(19) United States
(12) Patent Application Publication
(10) Pub. No.: US 2025/0251129 A1
(43) Pub. Date: Aug. 7, 2025

(54) GAS TURBINE ENGINE HAVING A STEAM GENERATING SYSTEM PROVIDING STEAM TO A COMBUSTOR

(71) Applicant: General Electric Company, Schenectady, NY (US)

(72) Inventors: Sripathi Mohan, Bengaluru (IN); Pradeep Naik, Bengaluru (IN); Perumallu Vukanti, Bengaluru (IN); Michael A. Benjamin, Cincinnati, OH (US); Clayton S. Cooper, Loveland, OH (US); Steven C. Vise, Loveland, OH (US)

(21) Appl. No.: 18/429,807

(22) Filed: Feb. 1, 2024

(51) Int. Cl. F23R 3/00; F23R 3/06

(52) U.S. Cl. CPC F23R 3/002; F02C 3/30; F23R 3/06

(57) ABSTRACT

A gas turbine engine includes a steam generating system and a combustor. The combustor includes a combustor liner defining a combustion chamber, an outer casing defining an outer airflow passage between the outer casing and the combustor liner, and an inner casing defining an inner airflow passage between the inner casing and the combustor liner. At least one steam injection nozzle extends through the outer casing or extends through the inner casing, and is arranged, during operation of the gas turbine engine, to provide a flow of steam generated by the steam generating system to a secondary combustion zone of the combustion chamber, without providing the steam to a primary combustion zone of the combustion chamber.

### TECHNICAL FIELD

The present disclosure relates generally to a gas turbine engine, and more particularly to a gas turbine engine including a steam generating system providing steam to a combustor.

### BACKGROUND

A combustor of a gas turbine engine generally includes a swirler that provides a flow of swirled air mixed with fuel into a combustion chamber, where the fuel and air mixture is ignited and burned. The burning of the fuel and air mixture in the combustion chamber results in carbon monoxide (CO) and nitrous oxide (NOₓ) emissions from the combustor. One technique to attempt to reduce the CO and the NOₓ emissions is to inject steam or water directly into the swirler via, for example, a fuel nozzle, to mix with the fuel and air mixture.

### BRIEF DESCRIPTION OF THE DRAWINGS

Features and advantages of the present disclosure will be apparent from the following description of various exemplary embodiments, as illustrated in the accompanying drawings, wherein like reference numbers generally indicate identical, functionally similar, and/or structurally similar elements.

FIG. 1 is a schematic partial cross-sectional side view of an exemplary high by-pass turbofan jet engine and a steam generating system, according to an aspect of the present disclosure.

FIG. 2 is a schematic diagram of the high by-pass turbofan jet engine and the steam generating system of FIG. 1, according to an aspect of the present disclosure.

FIG. 3 is a partial cross-sectional side view of an exemplary combustor of the turbo-engine as shown in FIG. 1, according to an aspect of the present disclosure.

FIG. 4 is a partial cross-sectional side view of a combustor with an alternate arrangement of steam injection nozzles to that shown in FIG. 3, according to an aspect of the present disclosure.

FIG. 5 is a partial cross-sectional side view of a combustor with another alternate arrangement of steam injection nozzles, according to an aspect of the present disclosure.

FIG. 6 is a partial cross-sectional aft looking view through the combustor of FIG. 5, taken at plane 6-6, according to an aspect of the present disclosure.

FIG. 7 is an enlarged detail view of an outer steam injection nozzle and an outer steam manifold, taken at detail view 201 of FIG. 5, according to an aspect of the present disclosure.

FIG. 8 is a partial cross-sectional view through the outer steam injection nozzle, taken at plane 8-8 of FIG. 7, according to an aspect of the present disclosure.

FIG. 9 is a partial cross-sectional side view of a combustor, with another alternate arrangement of steam injection nozzles, according to an aspect of the present disclosure.

FIG. 10 is a partial cross-sectional aft looking view of the combustor of FIG. 9, taken at plane 10-10 of FIG. 9, according to an aspect of the present disclosure.

FIG. 11 is a partial cross-sectional side view of a combustor, with another alternate arrangement of steam injection nozzles, according to an aspect of the present disclosure.

FIG. 12 in an enlarged, cross-sectional, detail view of a steam injection nozzle, taken at detail view 245 of FIG. 11, according to an aspect of the present disclosure.

FIG. 13A is a partial cross-sectional view through the steam injection nozzle of FIG. 12, taken at plane 13-13 of FIG. 12, according to an aspect of the present disclosure.

FIG. 13B depicts an alternate arrangement to the cross section of FIG. 13A, according to another aspect of the present disclosure.

FIG. 13C depicts still another alternate arrangement to the cross section of FIG. 13A, according to another aspect of the present disclosure.

FIG. 14 is a partial cross-sectional aft looking view of the combustor of FIG. 11, taken at plane 14-14 in FIG. 11, according to an aspect of the present disclosure.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments are discussed in detail below. While specific embodiments are discussed, this is done for illustration purposes only. A person skilled in the relevant art will recognize that other components and configurations may be used without departing from the present disclosure.

As used herein, the terms “first” or “second” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbine engine or a vehicle, and refer to the normal operational attitude of the turbine engine or the vehicle. For example, with regard to a turbine engine, forward refers to a position closer to an engine inlet and aft refers to a position closer to an engine nozzle or an exhaust.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a centerline of the aircraft gas turbine engine. Moreover, the terms “radial” and “radially” refer to directions and orientations that extend substantially perpendicular to the centerline of the aircraft gas turbine engine. In addition, as used herein, the terms “circumferential” and “circumferentially” refer to directions and orientations that extend arcuately about the centerline of the turbine engine.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

In aircraft gas turbine engines, a combustor may generally include a swirler that provides a flow of swirled air mixed with fuel into a combustion chamber, where a fuel and air mixture is ignited and burned. The burning of the fuel and air mixture in the combustion chamber results in carbon monoxide (CO) and nitrous oxide (NOₓ) emissions from the combustor. One technique to attempt to reduce the CO and the NOₓ emissions is to inject steam or water directly into the fuel and air mixture via, for example, a fuel nozzle, to mix with the fuel and air mixture within the swirler just prior to the mixture entering the combustion chamber for ignition. However, injecting steam directly into the fuel and air mixture within the swirler in this manner may result in a flameout condition, or may reduce the effectiveness and the efficiency of the combustion process such that not all of the fuel is ignited and burned within the combustor.

The present disclosure provides a technique to reduce CO and NOₓ emissions by including steam injection nozzles in a downstream end of a combustor so as to inject steam into a secondary combustion zone of a combustion chamber. Steam can be injected into the secondary combustion zone so that the steam can mix with combustion products within the combustion chamber in the secondary combustion zone, without injecting steam into a primary combustion zone. Thus, there is less of a chance of inducing a flameout condition within the primary combustion zone, while at the same time, reducing NOₓ and CO emissions from the combustor. In addition, the injection of the steam into the secondary combustion zone increases the density of the combustion gases flowing through a turbine section downstream of the combustor, thereby, providing thrust augmentation to the gas turbine engine when needed during a high power operating state.

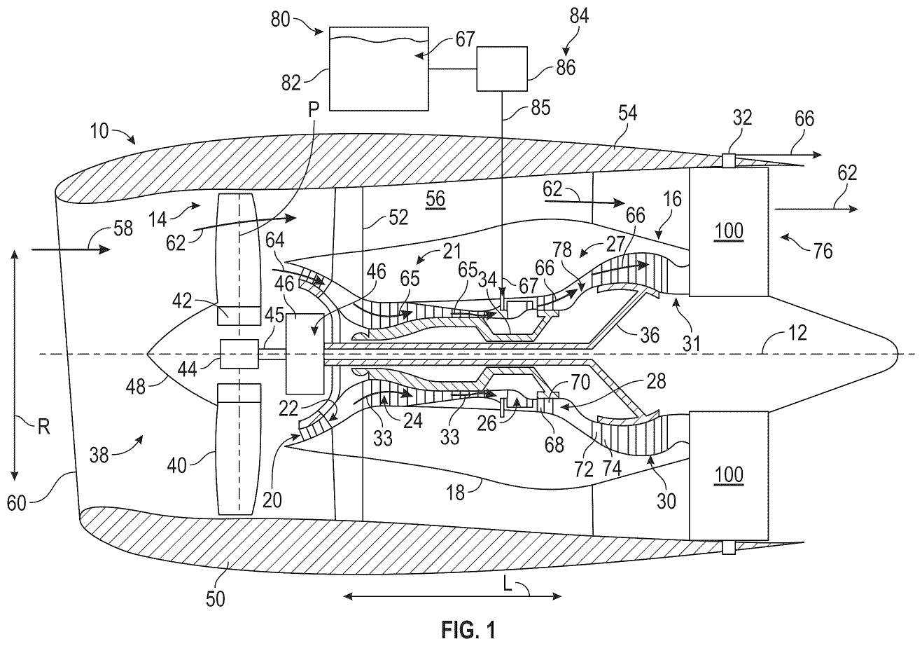

Referring now to the drawings, FIG. 1 is a schematic cross-sectional diagram of an aircraft gas turbine engine 10 that may be installed on an aircraft (not shown) and that includes a steam generating system 100 (described below), taken along a longitudinal centerline axis 12 (provided for reference) of the aircraft gas turbine engine 10, according to an embodiment of the present disclosure. The present disclosure may be implemented in any of various types of aircraft turbine engines, including high bypass turbofan engines, turbojet engines, and turboprop engines. As shown in FIG. 1, the aircraft gas turbine engine 10 has a longitudinal direction L (extending parallel to the longitudinal centerline axis 12) and a radial direction R that is normal to the longitudinal direction L. In general, the aircraft gas turbine engine 10 includes a fan section 14 and a turbo-engine 16 disposed downstream from the fan section 14.

The turbo-engine 16 includes an outer casing 18 that is substantially tubular and defines an annular inlet 20. As schematically shown in FIG. 1, the outer casing 18 encases, in serial flow relationship, a compressor section 21 including a booster or a low-pressure compressor (LPC) 22, followed downstream by a high-pressure compressor (HPC) 24, a combustor 26, a turbine section 27 including a high-pressure turbine (HPT) 28 followed downstream by a low-pressure turbine (LPT) 30, and an exhaust section 31 that includes one or more core exhaust nozzles 32. The compressor section 21, the combustor 26, the turbine section 27, and the exhaust section 31 including the one or more core exhaust nozzles 32 together define a core air flow path 33 therethrough. A high-pressure (HP) shaft 34 drivingly connects the HPT 28 to the HPC 24 to rotate the HPT 28 and the HPC 24 in unison. A low-pressure (LP) shaft 36 drivingly connects the LPT 30 to the LPC 22 to rotate the LPT 30 and the LPC 22 in unison.

For the embodiment depicted in FIG. 1, the fan section 14 includes a fan 38 (e.g., a variable pitch fan) having a plurality of fan blades 40 coupled to a disk 42 in a circumferentially spaced-apart manner. As depicted in FIG. 1, the fan blades 40 extend outwardly from the disk 42 generally along a radial direction R. Each fan blade 40 is rotatable relative to the disk 42 about a pitch axis P by virtue of the fan blades 40 being operatively coupled to an actuator 44 configured to collectively vary the pitch of the fan blades 40 in unison. The fan blades 40, the disk 42, and the actuator 44 are together rotatable about the longitudinal centerline axis 12 via a fan shaft 45 that is powered by the LP shaft 36 across a power gearbox, also referred to as a gearbox assembly 46. The gearbox assembly 46 is shown schematically in FIG. 1. The gearbox assembly 46 includes a plurality of gears (not shown) for adjusting the rotational speed of the fan shaft 45 and adjusting the rotational speed of the fan 38 relative to the LP shaft 36.

Referring still to the exemplary embodiment of FIG. 1, the disk 42 is covered by a rotatable fan hub 48 that is aerodynamically contoured to promote an airflow through the plurality of fan blades 40. In addition, the fan section 14 includes an annular fan casing or a nacelle 50 that circumferentially surrounds the fan 38 and/or at least a portion of the turbo-engine 16. The nacelle 50 is supported relative to the turbo-engine 16 by a plurality of circumferentially spaced struts or outlet guide vanes 52. Moreover, a downstream section 54 of the nacelle 50 extends over an outer portion of the turbo-engine 16 to define a bypass airflow passage 56 therebetween. The one or more core exhaust nozzles 32 may extend through the nacelle 50 and be formed therein. In the embodiment of FIG. 1, the one or more core exhaust nozzles 32 include one or more discrete nozzles that are spaced circumferentially about the nacelle 50. Other arrangements of the one or more core exhaust nozzles 32 may be used instead, including, for example, a single core exhaust nozzle that is annular, or partially annular, about the nacelle 50.

During a standard operating mode of the aircraft gas turbine engine 10, a volume of air 58 enters the aircraft gas turbine engine 10 through an inlet 60 of the nacelle 50 and/or the fan section 14. As the volume of air 58 passes across the fan blades 40, a first portion of air 58, shown as bypass air 62, is directed or routed into the bypass airflow passage 56, and a second portion of the air 58, shown as core air 64, is directed or is routed into the upstream section of the core air flow path 33, or, more specifically, into the annular inlet 20 of the LPC 22. A ratio between the bypass air 62 and the core air 64 is known as a bypass ratio. The pressure of the core air 64 is then increased by the LPC 22, generating compressed air 65, and the compressed air 65 is routed through the HPC 24, where being further compressed before being directed into the combustor 26. In the combustor 26, the compressed air 65 is mixed with fuel 67 and burned to generate combustion gases 66 (also referred to as combustion products). One or more stages may be used in each of the LPC 22 and the HPC 24, with each subsequent stage further compressing the compressed air 65.

The combustion gases 66 are routed from the combustor 26 into the HPT 28 and expanded through the HPT 28. In the HPT 28, a portion of thermal energy and/or kinetic energy from the combustion gases 66 is extracted via sequential stages of HPT stator vanes 68 that are coupled to the outer casing 18, and HPT rotor blades 70 that are coupled to rotors connected to the HP shaft 34, causing the HP shaft 34 to rotate, thereby supporting operation of the HPC 24. The combustion gases 66 are then routed into the LPT 30 and are further expanded through the LPT 30. Here, a second portion of the thermal energy and/or the kinetic energy is extracted from the combustion gases 66 via sequential stages of LPT stator vanes 72 that are coupled to the outer casing 18, and LPT rotor blades 74 that are coupled to LPT rotors connected to the LP shaft 36, causing the LP shaft 36 to rotate, thereby supporting operation of the LPC 22 and rotation of the fan 38 via the gearbox assembly 46. One or more stages may be used in each of the HPT 28 and the LPT 30. The combustion gases 66 are subsequently routed through the one or more core exhaust nozzles 32 of the turbo-engine 16 to provide propulsive thrust. Simultaneously with the flow of the core air 64 through the core air flow path 33, the bypass air 62 is routed through the bypass airflow passage 56 before being exhausted from a fan bypass nozzle 76 of the aircraft gas turbine engine 10, also providing propulsive thrust. The HPT 28, the LPT 30, and the one or more core exhaust nozzles 32 at least partially define a hot gas path 78 for routing the combustion gases 66 through the turbo-engine 16.

As noted above, the compressed air 65 is mixed with the fuel 67 in the combustor 26, and forms a fuel and air mixture that is combusted, generating the combustion gases 66 (combustion products). The fuel 67 can include any type of hydrocarbon fuel used for turbine engines, such as, for example, sustainable aviation fuels (SAF) including biofuels, Jet A, Jet A-1, or other hydrocarbon fuels. Other fuel types, which may or may not be hydrocarbon fuels, but that may generally be used in an aircraft gas turbine engine may also be utilized to implement the present disclosure. The aircraft gas turbine engine 10 also includes a fuel system 80 for providing the fuel 67 to the combustor 26. The fuel system 80 includes a fuel tank 82 for storing the fuel 67 therein, and a fuel delivery assembly 84. The fuel tank 82 can be located on the aircraft (not shown) to which the aircraft gas turbine engine 10 is attached. While a single fuel tank 82 is shown in FIG. 1, the fuel system 80 can include any number of fuel tanks 82, as desired. The fuel delivery assembly 84 delivers the fuel 67 from the fuel tank 82 to the combustor 26 via one or more fuel supply lines 85. The fuel delivery assembly 84 also includes a fuel pump 86 to induce the flow of the fuel 67 through the fuel supply lines 85 to the combustor 26. In this way, the fuel pump 86 pumps the fuel 67 from the fuel tank 82, through the fuel supply lines 85, and into the combustor 26.

The aircraft gas turbine engine 10 of the present disclosure includes the steam generating system 100, which, as will be described in more detail below, is in fluid communication with the one or more core exhaust nozzles 32 and the fan bypass nozzle 76. As will be described in more detail below, the steam generating system 100 generates steam utilizing the combustion gases 66 as the combustion gases 66 flow through the steam generating system 100, and may deliver at least a portion of the generated steam to the combustor 26.

The aircraft gas turbine engine 10 depicted in FIG. 1 is by way of example only. In other exemplary embodiments, the aircraft gas turbine engine 10 may have any other suitable configuration. For example, in other exemplary embodiments, the fan 38 may be configured in any other suitable manner (e.g., as a fixed pitch fan) and further may be supported using any other suitable fan frame configuration. Moreover, in other exemplary embodiments, any other suitable number or configuration of compressors, turbines, shafts, or a combination thereof may be provided. In still other exemplary embodiments, aspects of the present disclosure may be incorporated into any other suitable aircraft gas turbine engine, such as, for example, turbofan engines, propfan engines, and/or turboprop engines.

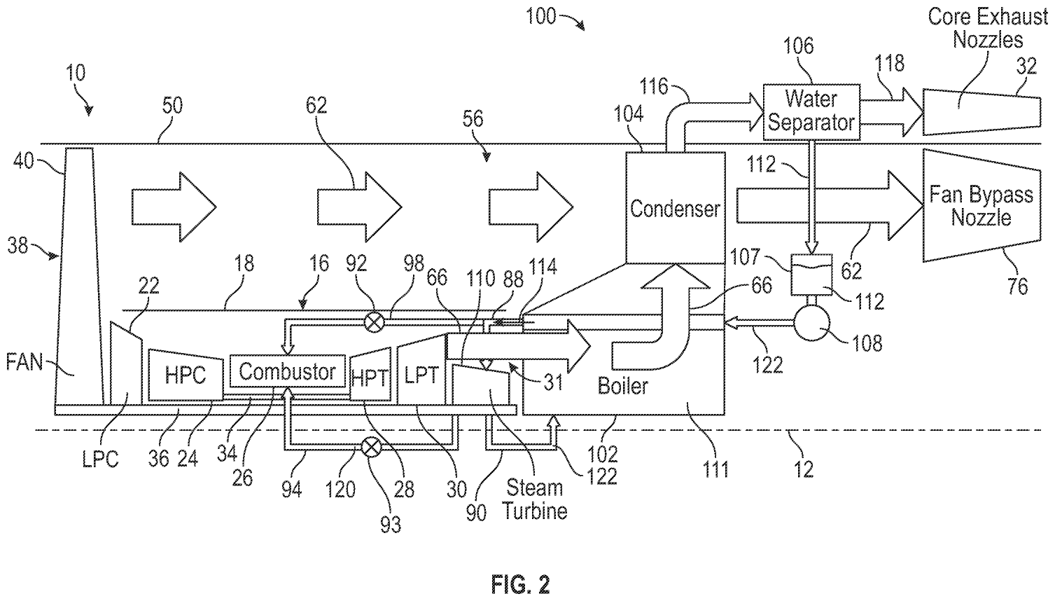

FIG. 2 is a schematic diagram of the aircraft gas turbine engine 10 and the steam generating system 100 of FIG. 1, according to an aspect of the present disclosure. For clarity, the aircraft gas turbine engine 10 is shown schematically in FIG. 2 and some components depicted and described above with regard to FIG. 1 are not shown in FIG. 2. As shown in FIG. 2, the steam generating system 100 includes a boiler 102, a condenser 104, a water/exhaust separator 106, a water pump 108, and a steam turbine 110.

The boiler 102 is a heat exchanger that vaporizes liquid water from a water source to generate steam or water vapor, as detailed further below. The boiler 102 is therefore a steam source. In particular, the boiler 102 is an exhaust gas-water heat exchanger in which the boiler 102 is in fluid communication with the hot gas path 78 (FIG. 1) and is positioned downstream of the LPT 30 so that the combustion gases 66 provide heat to the boiler 102 to boil water contained within the boiler 102. The boiler 102 is also in fluid communication with the water pump 108, as detailed further below, so as to replenish water within the boiler 102. The boiler 102 can include any type of boiler or heat exchanger for extracting heat from the combustion gases 66 and vaporizing liquid water into steam or water vapor as the liquid water and the combustion gases 66 flow through the boiler 102.

The condenser 104 is located downstream of the boiler 102 and is a heat exchanger that further cools the combustion gases 66 as the combustion gases 66 flow from the boiler 102 through the condenser 104, as detailed further below. In particular, the condenser 104 is an air-exhaust gas heat exchanger. The condenser 104 is in fluid communication with the boiler 102 and is positioned within the bypass airflow passage 56. The condenser 104 can include any type of condenser for condensing water from the exhaust (e.g., the combustion gases 66)

The water/exhaust separator 106 is located downstream of the condenser 104 and is in fluid communication with the condenser 104 for receiving, from the condenser 104, cooled exhaust (combustion gases 66) having condensed water entrained therein. The water/exhaust separator 106 is also in fluid communication with the one or more core exhaust nozzles 32 to provide separated exhaust gases thereto, and with a water storage tank 107 to provide separated water to the water storage tank 107. The water/exhaust separator 106 includes any type of water separator for separating water from the exhaust. For example, the water/exhaust separator 106 can include a cyclonic separator that uses vortex separation to separate the water from the exhaust. In such embodiments, the water/exhaust separator 106 generates a cyclonic flow within the water/exhaust separator 106 to separate the water from the cooled exhaust. In FIG. 2, the water/exhaust separator 106 is schematically depicted as being within the nacelle 50, but the water/exhaust separator 106 could be located at other locations within the aircraft gas turbine engine 10, such as, for example, radially inward of the nacelle 50, closer to the turbo-engine 16. The water/exhaust separator 106 may be driven to rotate by one of the engine shafts, such as the HP shaft 34 or the LP shaft 36, via, for example, an accessory gearbox (not shown).

As noted above, the boiler 102 receives liquid water from a water source to generate steam or water vapor. The water source may be the water storage tank 107 that is provided between the water/exhaust separator 106 and the water pump 108. In the embodiment depicted in FIG. 2, the water storage tank 107 may, therefore, be the water source for the boiler 102. The water pump 108 is in fluid communication with the water storage tank 107 and with the boiler 102. The water pump 108 may be any suitable pump, such as a centrifugal pump or a positive displacement pump. The water pump 108 directs separated water 112 that is stored in the water storage tank 107 to the boiler 102, where the separated water 112 is stored as water 111 that is then converted back to steam 114. The steam 114 is sent through the steam turbine 110 via a steam supply line 88 to provide work to drive the steam turbine 110, and a first portion 120 (also referred to as “steam 120”) of the remaining steam 114 from the steam turbine 110 may be routed to the combustor 26 via a steam supply line 94. Alternatively, a second portion 122 of the remaining steam 114 may be routed back into the boiler 102 via a steam supply line 90.

In operation of the steam generating system 100, the combustion gases 66, also referred to as exhaust, flow from the LPT 30 into the boiler 102 and then into the condenser 104. The combustion gases 66 transfer heat to the water 111 within the boiler 102 to generate the steam 114 within the boiler 102. The combustion gases 66 then flow into the condenser 104, where the condenser 104 condenses the water contained within the combustion gases 66. The bypass air 62 flows through the bypass airflow passage 56 and over or through the condenser 104, and extracts heat from the combustion gases 66, cooling the combustion gases 66 and condensing the water from the combustion gases 66, to generate an exhaust-water mixture 116. The bypass air 62 is then exhausted out of the aircraft gas turbine engine 10 through the fan bypass nozzle 76 to generate thrust, as detailed above. The condenser 104 may be positioned in the bypass airflow passage 56.

The exhaust-water mixture 116 flows into the water/exhaust separator 106. The water/exhaust separator 106 separates the water and the exhaust gases from the exhaust-water mixture 116 to generate separate exhaust gases 118 and the water 112. The exhaust gases 118 are exhausted out of the aircraft gas turbine engine 10 through the one or more core exhaust nozzles 32 to generate thrust, as detailed above. The boiler 102, the condenser 104, and the water/exhaust separator 106 also define a portion of the hot gas path 78 (FIG. 1) for routing the combustion gases 66, the exhaust-water mixture 116, and the exhaust gases 118 through the steam generating system 100 of the aircraft gas turbine engine 10.

The water pump 108 helps to urge the water 112 from the water/exhaust separator 106 into the water storage tank 107, and pumps the water 112 through one or more water lines (as indicated by the arrow for the water 112 in FIG. 2) so that the water 112 flows into the boiler 102 to mix with the water 111. The water 111 flows through the boiler 102 and the combustion gases 66 flowing through the boiler 102 transfer heat into the water 111 to vaporize the water 111 and to generate the steam 114.

The steam turbine 110 is coupled to the LP shaft 36, but may also be coupled to the HP shaft 34. The steam turbine 110 includes one or more stages of steam turbine blades (not shown) and steam turbine stators (not shown). The steam 114 flows from the boiler 102 via the steam supply line 88 into the steam turbine 110, causing the steam turbine blades of the steam turbine 110 to rotate, thereby generating additional work in the LP shaft 36. Additionally, at least a portion of the steam 114 may flow through one or more steam supply lines 98 into the combustor 26, and a steam supply control valve 92 may be provided within the steam supply line 98 to control a flow of the steam 114 into the combustor 26. As for the steam 114 provided to the steam turbine 110, the steam 120 of the remaining steam 114 may then flow from the steam turbine 110, through the one or more steam supply lines 94 and into the combustor 26, and a steam supply control valve 93 may be included within the steam supply lines 94. Alternatively, the second portion 122 of the remaining steam 114 may then flow from the steam turbine 110, through the one or more steam supply lines 90, back into the boiler 102.

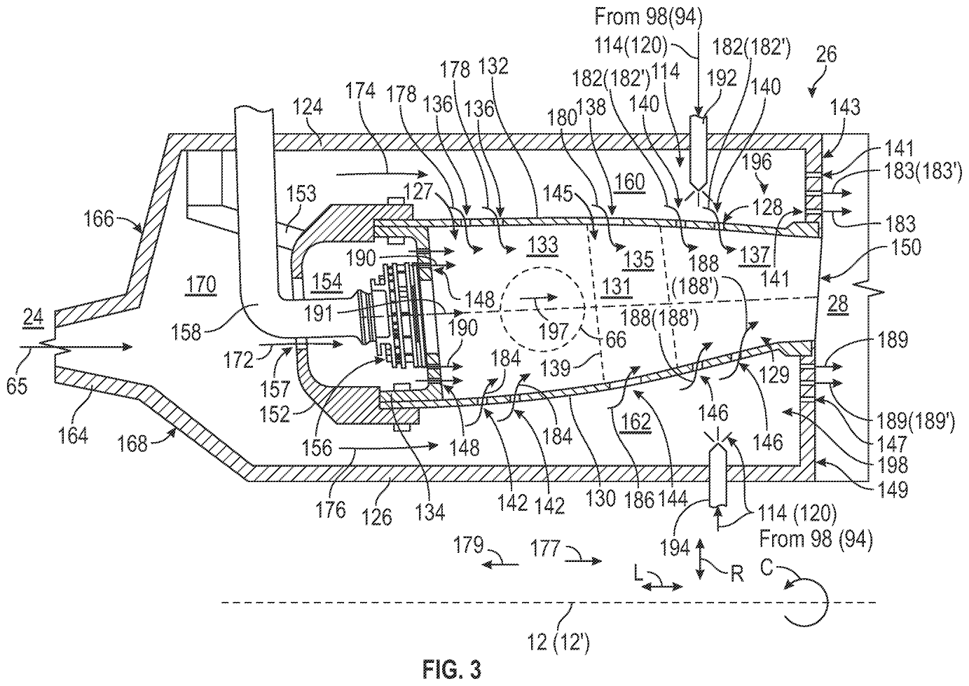

FIG. 3 is a partial cross-sectional side view of an exemplary combustor 26 of the turbo-engine 16 as shown in FIG. 1, according to an aspect of the present disclosure. The exemplary combustor 26 shown in FIG. 3 is depicted as an annular type combustion section that extends circumferentially about the longitudinal centerline axis 12, even though only an upper portion (above the longitudinal centerline axis 12) is shown in FIG. 3. With respect to the combustor 26, the longitudinal centerline axis 12 of the gas turbine engine 10 may also correspond to a combustor longitudinal centerline axis 12′. The combustor 26 includes an outer casing 124, an inner casing 126, and a combustor liner 128 arranged between the outer casing 124 and the inner casing 126. As shown in FIG. 3, the combustor liner 128 includes an inner liner 130, an outer liner 132, and a dome structure 134, each of which extends circumferentially about the combustor longitudinal centerline axis 12′. The outer liner 132 may include various liner openings therethrough, including a plurality of primary combustion zone liner openings 136, a plurality of outer liner dilution openings 138 (one shown in FIG. 3), and a plurality of secondary combustion zone liner openings 140. Similarly, the inner liner 130 may include various openings therethrough, including a plurality of primary combustion zone liner openings 142, a plurality of inner liner dilution openings 144 (one shown in FIG. 3), and a plurality of secondary combustion zone liner openings 146. In addition, the dome structure 134 may include a plurality of cooling airflow openings 148 therethrough. In addition, a downstream end 143 of the outer casing 124 may include a plurality of turbine cooling openings 141 to provide a flow of turbine cooling air 183 into the HPT 28, and a downstream end 149 of the inner casing 126 may include a plurality of turbine cooling openings 147 to provide a flow of turbine cooling air 189 to the HPT 28. As will be described in more detail below, each of the various openings through the inner liner 130, through the outer liner 132, and through the dome structure 134 allow for air to flow into a combustion chamber 131 to provide cooling of the combustor liner 128, or to the dome structure 134, or to provide quenching of the combustion gases 66 within the combustion chamber 131. In addition, as will be described in more detail below, the air flowing through the various openings may be mixed with steam to help to reduce NOₓ emissions, or to augment thrust of the gas turbine engine 10.

The combustor 26 further includes a plurality of swirler assemblies 156 (one shown in FIG. 3) that are connected to the dome structure 134, and a plurality of fuel nozzle assemblies 158 (one shown in FIG. 3) that are connected to respective ones of the plurality of swirler assemblies 156.

The inner liner 130 and the outer liner 132 are connected to the dome structure 134, thereby defining the combustion chamber 131 therebetween. The inner liner 130 and the outer liner 132 extend from the dome structure 134 to a combustor outlet 150 at an entry to the HPT 28 (FIG. 1), at least partially defining a hot gas path between the dome structure 134 and the HPT 28. The combustion chamber 131 may be theoretically divided into a primary combustion zone 133 in an upstream portion 127 of the combustor liner 128, and a secondary combustion zone 137 in a downstream portion 129 of the combustor liner 128. The primary combustion zone 133 may extend from the dome structure 134 to a beginning of a dilution zone 135, which in FIG. 3 is demarked as a dashed line 139 that extends between an upstream side of the outer liner dilution openings 138 to an upstream side of the inner liner dilution openings 144. The dilution zone 135 is part of the secondary combustion zone 137, and the dilution zone 135 is an area of the combustion chamber 131 where initial quenching of the combustion gases 66 occurs as dilution airflow (described below) flows through the outer liner dilution openings 138 and through the inner liner dilution openings 144 into the dilution zone 135. The outer liner dilution openings 140 and the inner liner dilution openings 144 are arranged at an upstream end 145 of the secondary combustion zone 137.

The combustor 26 further includes a cowl 152 that is connected to the inner liner 130, to the outer liner 132, and to the dome structure 134, thereby defining a plenum 154 therewithin. The cowl 152 extends circumferentially about the combustor longitudinal centerline axis 12′ and may be formed of a single cowl structure, or, may formed of multiple cowl structures that are connected together. The cowl 152 includes a plurality of cowl airflow openings 157 (one shown in FIG. 3), where each cowl airflow opening 157 corresponds to a respective one of the plurality of swirler assemblies 156. As will be described below, each cowl airflow opening 157 provides a flow of air therethrough into the plenum 154. The cowl 152 is connected to the outer casing 124 via a cowl mounting arm 153.

As shown in FIG. 3, the outer casing 124 and the inner casing 126 surround the combustor liner 128. An outer airflow passage 160 is defined between the outer casing 124 and the outer liner 132, and an inner airflow passage 162 is defined between the inner casing 126 and the inner liner 130. A diffuser 164 is connected to the combustor 26 between an upstream end 166 of the outer casing 124 and an upstream end 168 of the inner casing 126. A pressure plenum 170 is defined between the upstream end 166 of the outer casing 124 and the upstream end 168 of the inner casing 126. The diffuser 164 provides a flow of the compressed air 65 from the HPC 24 into the pressure plenum 170.

Referring still to FIG. 3, during operation of the aircraft gas turbine engine 10, the compressed air 65 flows through the diffuser 164 and into the pressure plenum 170 of the combustor 26 to pressurize the pressure plenum 170. A first portion of the compressed air 65 in the pressure plenum 170, as indicated schematically by an arrow denoting compressed air 172, flows from the pressure plenum 170 into the plenum 154 of the cowl 152. The compressed air 172 then flows through the swirler assemblies 156, where the compressed air 172 is mixed with fuel provided to the swirler assemblies 156 by the fuel nozzle assemblies 158. A swirler fuel-air mixture 191 is then injected into the combustion chamber 131 by the swirler assemblies 156, and the swirler fuel-air mixture 191 is ignited by an ignitor (not shown) and burned to generate the combustion gases 66 within the combustion chamber 131. The initial combustion (ignition and burning) of the swirler fuel-air mixture 191 occurs within the primary combustion zone 133, and the combustion gases 66 generally flow in an axial flow direction 197 within the combustion chamber 133. A portion of the compressed air 172 within the plenum 154, shown schematically by arrows denoting cooling air 190, may flow through the cooling airflow openings 148 in the dome structure 134 to provide cooling of a downstream side of the dome structure 134. While not shown in FIG. 3, the dome structure 134 may include a deflector or a heat shield on the downstream side to protect the dome structure 134 from heat generated in the combustion chamber 131, and the cooling airflow openings 148 may also be provided through the deflector or the heat shield.

A second portion of the compressed air 65 in the pressure plenum 170, as indicated schematically by arrows denoting compressed air 174 and compressed air 176, may be routed into the outer airflow passage 160, and into the inner airflow passage 162, respectively. The compressed air 174 and the compressed air 176 flow in a downstream direction 177 within the outer airflow passage 160 and the inner airflow passage 162, respectively, whereas, as will be described below, steam may be injected into the outer airflow passage 160 and into the inner airflow passage 162 in an upstream direction 179. A portion of the compressed air 174 flowing through the outer airflow passage 160, shown schematically as cooling air 178, may be routed through the plurality of primary combustion zone liner openings 136 into the combustion chamber 131. Another portion of the compressed air 174 flowing through the outer airflow passage 160, shown schematically as dilution airflow 180, may be routed through the outer liner dilution openings 138 into the dilution zone 135 of the combustion chamber 131 to provide quenching of the combustion gases 66. Yet another portion of the compressed air 174 flowing through the outer airflow passage 160, shown schematically as cooling air 182, may be routed through the secondary combustion zone liner openings 140 into the secondary combustion zone 137 of the combustion chamber 131.

Similarly, a portion of the compressed air 176 flowing through the inner airflow passage 162, shown schematically as cooling air 184, may be routed through the plurality of primary combustion zone liner openings 142 into the primary combustion zone 133 of the combustion chamber 131. Another portion of the compressed air 176 flowing through the inner airflow passage 162, shown schematically as dilution airflow 186, may be routed through the inner liner dilution openings 144 of the inner liner 130 into the dilution zone 135 of the combustion chamber 131 to provide quenching of the combustion gases 66. Yet another portion of the compressed air 176 flowing through the inner airflow passage 162, shown schematically as cooling air 188, may be routed through the secondary combustion zone liner openings 146 into the secondary combustion zone 137 of the combustion chamber 131.

As further shown in FIG. 3, the combustor 26 may include at least one outer steam injection nozzle 192 that extends through the outer casing 124, or may include at least one inner steam injection nozzle 194 that extends through the inner casing 126. The combustor 26 may include one of the outer steam injection nozzle 192 or the inner steam injection nozzle 194, or, may include both the outer steam injection nozzle 192 and the inner steam injection nozzle 194. The outer steam injection nozzle 192 and the inner steam injection nozzle 194 are connected to the steam supply line 98 and to the steam supply line 94. The outer steam injection nozzle 192 is arranged to inject the steam 114 or the steam 120 into a downstream portion 196 of the outer airflow passage 160, and the inner steam injection nozzle 194 is arranged to inject the steam 114 or the steam 120 into a downstream portion 198 of the inner airflow passage 162. In particular, in the FIG. 3 aspect, the outer steam injection nozzle 192 is arranged downstream of the outer liner dilution openings 138, and the inner steam injection nozzle 194 is arranged downstream of the inner liner dilution openings 144. The velocity of the compressed air 174 within the outer airflow passage 160 is generally high enough such that the steam 114 or the steam 120 injected into the downstream portion 196 of the outer airflow passage 160 will not flow back upstream beyond the outer liner dilution openings 138. Instead, the steam 114 or the steam 120 that is injected into the downstream portion 196 of the outer airflow passage 160 mixes with the compressed air 174 in the downstream portion 196 of the outer airflow passage 160 to generate a steam-air mixture 182′, and the steam-air mixture 182′ flows through the secondary combustion zone liner openings 140 and into the secondary combustion zone 137 of the combustion chamber 131. Some of the steam-air mixture 182′ may also flow through the turbine cooling openings 141 as a steam-air mixture 183′ into the turbine HPT 28. Moreover, the steam supply control valve 92 and the steam supply control valve 93 (FIG. 2) can control the amount of the steam 114 or the amount of the steam 120, respectively, provided to the outer steam injection nozzle 192 so as to prevent a back-flow of the steam 114 or the steam 120 beyond the outer liner dilution openings 138. As a result, the steam 114 or the steam 120 can be provided to the secondary combustion zone 137 without being provided to the primary combustion zone 133, thereby, reducing a possibility of inducing a flameout condition within the primary combustion zone 133, while also reducing CO and NOₓ emissions in the combustion gases 66 as the combustion gases 66 flow through the secondary combustion zone 137.

Similarly, with regard to the inner steam injection nozzle 194 injecting the steam 114 into the downstream portion 198 of the inner airflow passage 162, the velocity of the compressed air 176 within the inner airflow passage 162 is generally high enough such that, the steam 114 or the steam 120 injected into the downstream portion 198 of the inner airflow passage 162 will not flow back upstream beyond the inner liner dilution openings 144. Instead, the steam 114 or the steam 120 that is injected into the downstream portion 198 of the inner airflow passage 162 mixes with the compressed air 176 in the downstream portion 198 of the inner airflow passage 162 to generate a steam-air mixture 188′, and the steam-air mixture 188′ then flows through the secondary combustion zone liner openings 146 and into the secondary combustion zone 137 of the combustion chamber 131. Some of the steam-air mixture 188′ may also flow through the turbine cooling openings 147 as a steam-air mixture 189′ into the turbine HPT 28. Again, the steam supply control valve 92 and the steam supply control valve 93 (FIG. 2) can control the amount of the steam 114 or the amount of the steam 120, respectively, provided to the inner steam injection nozzle 194 so as to prevent a back-flow of the steam 114 or the steam 120 beyond the inner liner dilution openings 144. As a result, the steam 114 or the steam 120 can be provided to the secondary combustion zone 137 without being provided to the primary combustion zone 133, thereby, reducing a possibility of inducing a flameout condition within the primary combustion zone 133, while also reducing CO and NOₓ emissions in the combustion gases 66 as the combustion gases 66 flow through the secondary combustion zone 137.

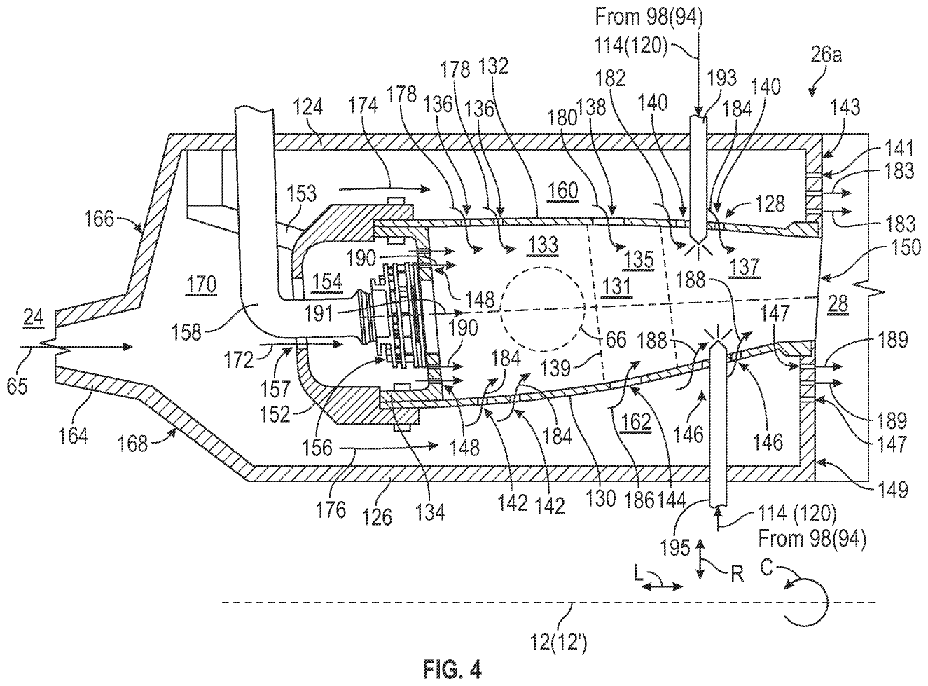

FIG. 4 is a partial cross-sectional side view of a combustor 26a, with an alternate arrangement of steam injection nozzles to that shown in FIG. 3, according to an aspect of the present disclosure. In the FIG. 4 aspect, elements that are the same as those in the FIG. 3 aspect have the same references numbers and the description of those elements will not be repeated here. In the FIG. 4 aspect, an outer steam injection nozzle 193 extends through the outer airflow passage 160 and through the outer liner 132 so as to provide the flow of the steam 114 or the steam 120 directly into the secondary combustion zone 137 of the combustion chamber 131. The outer steam injection nozzle 193 may extend through one of the secondary combustion zone liner openings 140 through the outer liner 132. Similarly, the combustor 26a includes an inner steam injection nozzle 195 that extends through the inner airflow passage 162 and through the inner liner 130 so as to provide the flow of the steam 114 or the steam 120 directly into the secondary combustion zone 137 of the combustion chamber 131. The inner steam injection nozzle 195 may extend through one of the secondary combustion zone liner openings 146 of the inner liner 130. The steam 114 or the steam 120 can interact with, and mix with, the combustion gases 66 within the secondary combustion zone 137 rather than first mixing with the compressed air 174 within the outer airflow passage 160, or rather than first mixing with the compressed air 176 within the inner airflow passage 162.

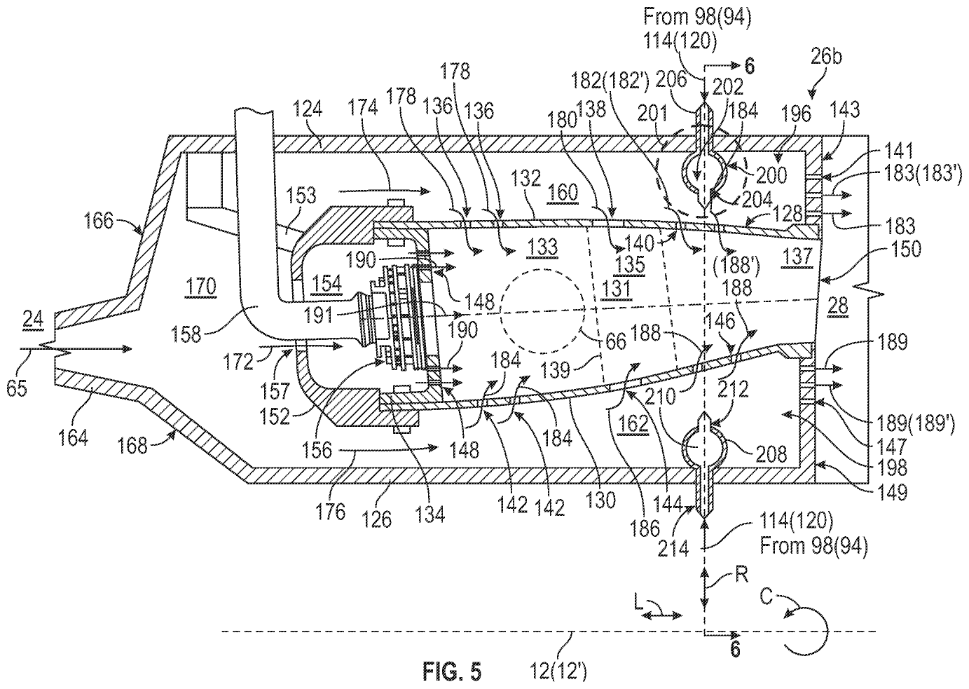

FIG. 5 is a partial cross-sectional side view of a combustor 26b, with an alternate arrangement of steam injection nozzles, according to an aspect of the present disclosure. In the FIG. 5 aspect, elements that are the same as those in the FIG. 3 aspect have the same references numbers and the description of those elements will not be repeated here. In FIG. 5, the combustor 26b includes an outer steam manifold 200 that may be connected to an inner side of the outer casing 124. The outer steam manifold 200 has a steam passage 202, and at least one outer steam injection nozzle 204 is connected to the outer steam manifold 200 and is in fluid communication with the steam passage 202. The outer steam manifold 200 is also connected to a steam supply line connector 206 that is connected to the steam supply line 98 and to the steam supply line 94. The steam 114 or the steam 120 is provided to the outer steam manifold 200 from the steam supply line 98 or from the steam supply line 94, and the steam fills the steam passage 202 and then flows through the at least one outer steam injection nozzle 204 into the outer airflow passage 160. In the same manner described above for the FIG. 3 aspect, the steam 114 or the steam 120 mixes with the compressed air 174 in the downstream portion 196 of the outer airflow passage 160 to generate the steam-air mixture 182′ that then flows through the secondary combustion zone liner openings 140 into the secondary combustion zone 137.

The combustor 26b of FIG. 5 also includes an inner steam manifold 208 that may be connected to an outer side of the inner casing 126. The inner steam manifold 208 has a steam passage 210, and at least one inner steam injection nozzle 212 is connected to the inner steam manifold 208 and is in fluid communication with the steam passage 210. The inner steam manifold 208 is also connected to a steam supply line connector 214 that is connected to the steam supply line 98 and to the steam supply line 94. The steam 114 or the steam 120 is provided to the inner steam manifold 208 from the steam supply line 98 or from the steam supply line 94, and the steam fills the steam passage 210 and then flows through the at least one inner steam injection nozzle 212 into the inner airflow passage 162. In the same manner described above for the FIG. 3 aspect, the steam 114 or the steam 120 mixes with the compressed air 176 in the downstream portion 198 of the inner airflow passage 162 to generate the steam-air mixture 188′ that then flows through the secondary combustion zone liner openings 146 into the secondary combustion zone 137.

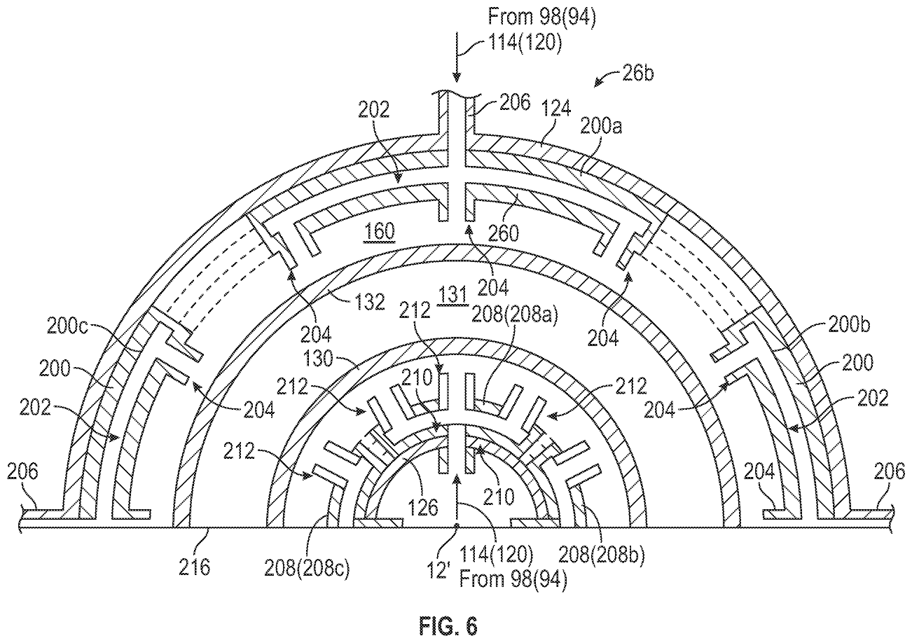

FIG. 6 is a partial cross-sectional aft looking view through the combustor 26b of FIG. 5, taken at plane 6-6 of FIG. 5, according to an aspect of the present disclosure. In FIG. 6, only an upper half of the combustor 26b above a horizontal reference plane 216 through the combustor longitudinal centerline axis 12′ is shown, but a lower half of the combustor 26b below the horizontal reference plane 216 may be a mirror image of the upper half as shown in FIG. 6. As shown in FIG. 6, the combustor 26b may include a plurality of the outer steam manifolds 200, including a first outer steam manifold 200a, a second outer steam manifold 200b (shown partially in FIG. 6), and a third outer steam manifold 200c (also shown partially in FIG. 6). Each of the outer steam manifolds 200 extends at least partially annularly about the combustor longitudinal centerline axis 12′. In addition, each outer steam manifold 200 includes a plurality of outer steam injection nozzles 204 that extend into the outer airflow passage 160. Alternatively, rather than including a plurality of the outer steam manifolds 200, a single annular outer steam manifold may be provided (as indicated by the dashed lines connecting, for example, the first outer steam manifold 200a with the second outer steam manifold 200b, and the dashed lines connecting the first outer steam manifold 200a with the third outer steam manifold 200c, and continuing about the combustor longitudinal centerline axis 12 for the mirror image lower half).

Similarly, the combustor 26b may include a plurality of the inner steam manifolds 208, including a first inner steam manifold 208a, a second inner steam manifold 208b (shown partially in FIG. 6), and a third inner steam manifold 208c (also shown partially in FIG. 6). Each of the inner steam manifolds 208 extends at least partially annularly about the combustor longitudinal centerline axis 12′. In addition, the inner steam manifold 208 includes a plurality of inner steam injection nozzles 212 that extend into the inner airflow passage 162. Alternatively, rather than including a plurality of the inner steam manifolds 208, a single annular inner steam manifold may be provided (as indicated by the dashed lines connecting, for example, the first inner steam manifold 208a with the second inner steam manifold 208b, and the dashed lines connecting the first inner steam manifold 208a with the third inner steam manifold 208c, and continuing about the combustor longitudinal centerline axis 12 for the mirror image lower half).

While FIG. 5 and FIG. 6 depict the combustor 26b as including both the outer steam manifolds 200 having the outer steam injection nozzles 204, and the inner steam manifolds 208 having the inner steam injection nozzles 212, the combustor 26b need not include both. Rather, the combustor 26b may include either the outer steam manifold 200 with the outer steam injection nozzles 204, or the inner steam manifold 208 with the inner steam injection nozzles 212.

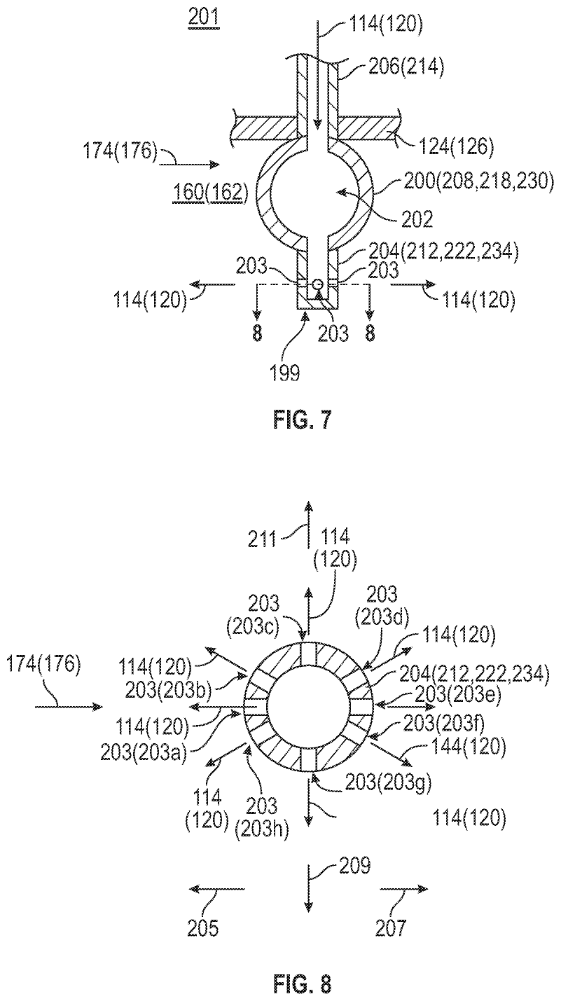

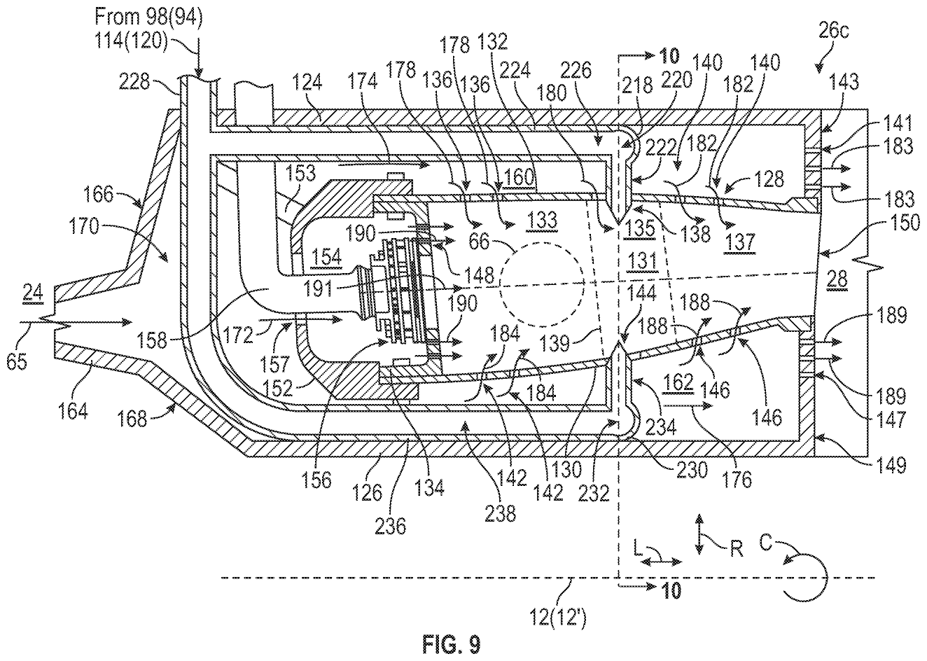

FIG. 7 is an enlarged, cross-sectional, detail view of an outer steam injection nozzle 204 and an outer steam manifold 200, taken at detail view 201 of FIG. 5, according to an aspect of the present disclosure. FIG. 8 is a partial cross-sectional view through the outer steam injection nozzle 204, taken at plane 8-8 of FIG. 7, according to an aspect of the present disclosure. Referring collectively to FIG. 7 and to FIG. 8, the outer steam injection nozzle 204 has a closed tip 199 and includes a plurality of steam injection ports 203. Although eight steam injection ports 203 are shown in FIG. 8, more than eight steam injection ports 203, or fewer than eight steam injection ports 203, may be included in the outer steam injection nozzle 204. In addition, while FIG. 8 depicts the steam injection ports 203 as being in a same plane (i.e., the plane 8-8), the steam injection ports 203 may be provided on different planes (e.g., one or more planes above plane 8-8 or one or more planes below plane 8-8) instead.

The steam injection ports 203 are also shown to direct the flow of the steam 114

or the flow of the steam 120 in different directions within the outer airflow passage 160. For example, a first steam injection port 203a is arranged to direct the flow of the steam 114 or the steam 120 in an upstream direction 205. A second steam injection port 203b is arranged to direct the flow of the steam 114 or the steam 120 in an upstream-lateral direction that directs the steam 114 or the steam 120 in both the upstream direction 205 and in a second lateral direction 211. A third steam injection port 203c is arranged to direct the flow of the steam 114 or the flow of the steam 120 in the second lateral direction 211. A fourth steam injection port 203d is arranged to direct the flow of the steam 114 or the steam 120 in a downstream-lateral direction that directs the steam 114 or the steam 120 in both the second lateral direction 211 and in a downstream direction 207. A fifth steam injection port 203e is arranged to direct the flow of the steam 114 or the steam 120 in the downstream direction 207. A sixth steam injection port 203f is arranged to direct the flow of the steam 114 or the steam 120 in a downstream-lateral direction that directs the steam 114 or the steam 120 in both the downstream direction 207 and in a first lateral direction 209. A seventh steam injection port 203g is arranged to direction the flow of the steam 114 or the flow of the steam 120 in the first lateral direction 209. An eighth steam injection port 203h is arranged to direct the flow of the steam 114 or the steam 120 in an upstream-lateral direction that directs the steam 114 or the steam 120 in both the first lateral direction 209 and in the upstream direction 205. Therefore, the steam injection ports 203 can spread the flow of the steam 114 or the steam 120 in different directions within the outer airflow passage 160 to better mix with the compressed air 174. Of course, other arrangements of the steam injection ports 203 can be implemented instead, and the present disclosure is not limited to the arrangement shown in FIG. 7 and FIG. 8. In addition, while FIG. 7 and FIG. 8 describe the outer steam manifold 200 and the outer steam injection nozzle 204, the arrangement in FIG. 7 and FIG. 8 is equally applicable for the inner steam manifold 208 and the inner steam injection nozzle 212.

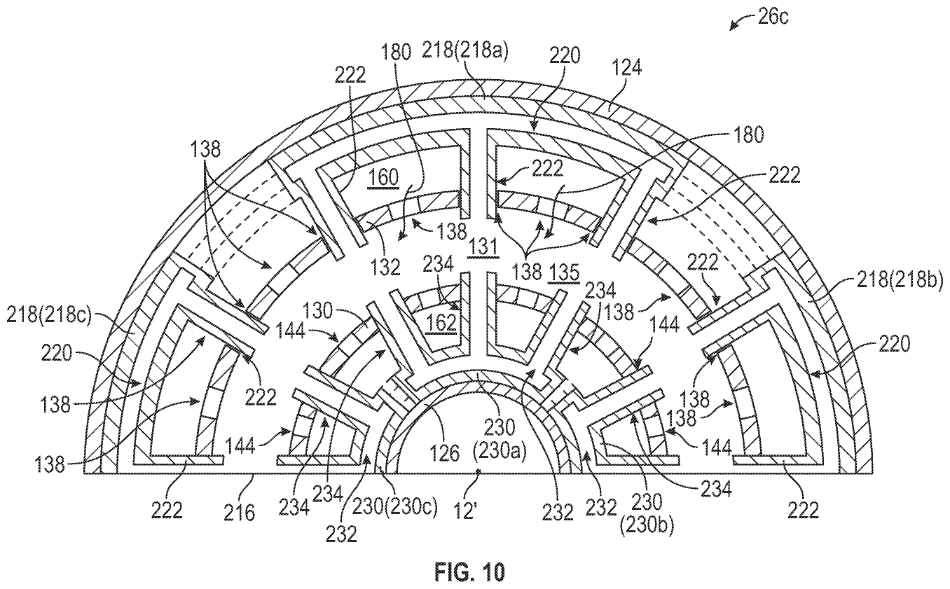

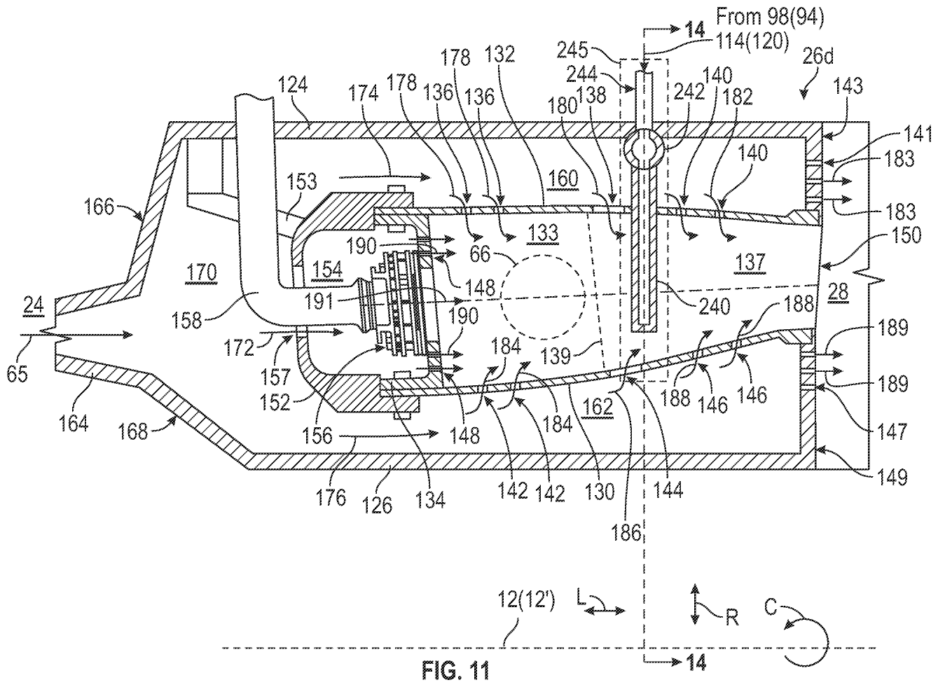

FIG. 9 is a partial cross-sectional side view of a combustor 26c, with another alternate arrangement of steam injection nozzles, according to an aspect of the present disclosure. FIG. 10 is a partial cross-sectional aft looking view of the combustor 26b, taken at plane 10-10 of FIG. 9, according to an aspect of the present disclosure. In FIG. 10, only an upper half of the combustor 26c above the horizontal reference plane 216 through the combustor longitudinal centerline axis 12′ is shown, but the lower half of the combustor 26c below the horizontal reference plane may be a mirror image of the upper portion as shown in FIG. 10. Referring collectively to FIG. 9 and to FIG. 10, elements that are the same as those in the FIG. 3, FIG. 5, and FIG. 6 aspects have the same references numbers and the description of those elements will not be repeated here. In the FIG. 9 and FIG. 10 aspects, one difference between the combustor 26b and the combustor 26c of FIG. 5 and FIG. 6, respectively, is that steam injection nozzles are arranged to inject the steam 114 directly into the combustion chamber 131 rather than injecting the steam 114 into the outer airflow passage 160 or into the inner airflow passage 162. In FIG. 9 and FIG. 10, the combustor 26c includes an outer steam manifold 218 having a steam passage 220 therewithin, and a plurality of outer steam injection nozzles 222 that are in fluid communication with the outer steam manifold 218. The outer steam manifold 218 may also be connected to an outer steam supply line 224 that has a steam passage 226 therewithin to supply the steam 114 to the outer steam manifold 218. The outer steam supply line 224 is connected to a steam supply line connector 228 that is connected to the steam supply line 98 (FIG. 2) or to the steam supply line 94 (FIG. 2). Alternatively, the outer steam manifold 218 may include the steam supply line connector 206 as shown in FIG. 5, rather than having the outer steam supply line 224. Similar to the outer steam manifold 200 as shown in FIG. 6, in FIG. 10, the outer steam manifold 218 extends at least partially annularly about the combustor longitudinal centerline axis 12′, and may include a plurality of outer steam manifolds 218, including a first outer steam manifold 218a, a second outer steam manifold 218b, and a third outer steam manifold 218c. Similar to the FIG. 6 aspect, the outer steam manifold 218 may instead extend annularly about the combustor longitudinal centerline axis 12′, as indicated by, for example, the dashed lines connecting the first outer steam manifold 218a with the second outer steam manifold 218b, and the dashed lines connecting the first outer steam manifold 218a with the third outer steam manifold 218c.

As was described above for FIG. 3, the outer liner 132 includes the plurality of outer liner dilution openings 138 therethrough. FIG. 10 depicts the plurality of outer liner dilution openings 138 being circumferentially spaced apart about the combustor longitudinal centerline axis 12′. In the FIG. 9 and FIG. 10 aspects, respective ones of the plurality of outer steam injection nozzles 222 extend through a respective one of the outer liner dilution openings 138 through the outer liner 132. The outer steam injection nozzles 222 extend into the combustion chamber 131, and, more particularly, extend into the dilution zone 135 of the combustion chamber 131. As shown in FIG. 10, the outer liner 132 may include more outer liner dilution openings 138 than the number of outer steam injection nozzles 222. Therefore, at least one outer liner dilution opening 138 may be arranged between a respective pair of the outer steam injection nozzles 222. Such an arrangement allows for the dilution airflow 180 to flow through the outer liner dilution openings 138 that do not have an outer steam injection nozzle 222 extending therethrough. On the other hand, the outer steam injection nozzles 222 can inject the steam 114 or the steam 120 directly into the dilution zone 135 rather than injecting the steam 114 or the steam 120 into the outer airflow passage 160.

Similarly, the combustor 26c includes an inner steam manifold 230 having a steam passage 232 therewithin, and a plurality of inner steam injection nozzles 234 that are in fluid communication with the inner steam manifold 230. The inner steam manifold 230 may also be connected to an inner steam supply line 236 that has a steam passage 238 therewithin to supply the steam 114 or the steam 120 to the inner steam manifold 230. The inner steam supply line 236 is connected to the steam supply line connector 228 that is connected to the steam supply line 98 (FIG. 2) or to the steam supply line 94 (FIG. 2). Therefore, both the outer steam manifold 218 and the inner steam manifold 230 can be supplied with the steam 114 or the steam 120 via a single connection (i.e., via the steam supply line connector 228). Alternatively, the inner steam manifold 230 may include the steam supply line connector 214 as shown in FIG. 5, rather than having the inner steam supply line 236.

Similar to the inner steam manifold 208 as shown in FIG. 6, the inner steam manifold 230 of FIG. 10 extends at least partially annularly about the combustor longitudinal centerline axis 12′, and may including a plurality of inner steam manifolds 230, including a first inner steam manifold 230a, a second inner steam manifold 230b, and a third inner steam manifold 230c. Similar to the FIG. 6 aspect, the inner steam manifold 230 may instead extend annularly about the combustor longitudinal centerline axis 12′, as indicated by, for example, the dashed lines connecting the first inner steam manifold 230a with the second inner steam manifold 230b, and the dashed lines connecting the first inner steam manifold 230a with the third inner steam manifold 230c.

As was described above for FIG. 3, the inner liner 130 includes the plurality of inner liner dilution openings 144 therethrough. FIG. 10 depicts the plurality of inner liner dilution openings 144 being circumferentially spaced apart about the combustor longitudinal centerline axis 12′. In the FIG. 9 and FIG. 10 aspects, respective ones of the plurality of inner steam injection nozzles 234 extend through a respective one of the inner liner dilution openings 144 through the inner liner 130. The inner steam injection nozzles 234 extend into the combustion chamber 131, and, more particularly, extend into the dilution zone 135 of the combustion chamber 131. As shown in FIG. 10, the inner liner 130 may include more inner liner dilution openings 144 than the number of inner steam injection nozzles 234. Therefore, at least one inner liner dilution opening 144 may be arranged between a respective pair of the inner steam injection nozzles 234. Such an arrangement allows for the dilution airflow 186 to flow through the inner liner dilution openings 144 that do not have an inner steam injection nozzle 234 extending therethrough. On the other hand, the inner steam injection nozzles 234 can inject the steam 114 or the steam 120 directly into the dilution zone 135, rather than injecting the steam 114 or the steam 120 into the inner airflow passage 162.

While FIG. 9 and FIG. 10 depict the combustor 26c as including both the outer steam manifolds 218 having the outer steam injection nozzles 222, and the inner steam manifolds 230 having the inner steam injection nozzles 234, the combustor 26c need not include both. Rather, the combustor 26c may include either the outer steam manifold 218 with the outer steam injection nozzles 222, or the inner steam manifold 230 with the inner steam injection nozzles 234. In addition, the arrangement of the outer steam manifold 218 and the outer steam injection nozzle 222 may be similar to that as shown in FIG. 7 and in FIG. 8. The arrangement of the inner steam manifold 230 and the inner steam injection nozzle 234 may also be similar to that as shown in FIG. 7 and FIG. 8.

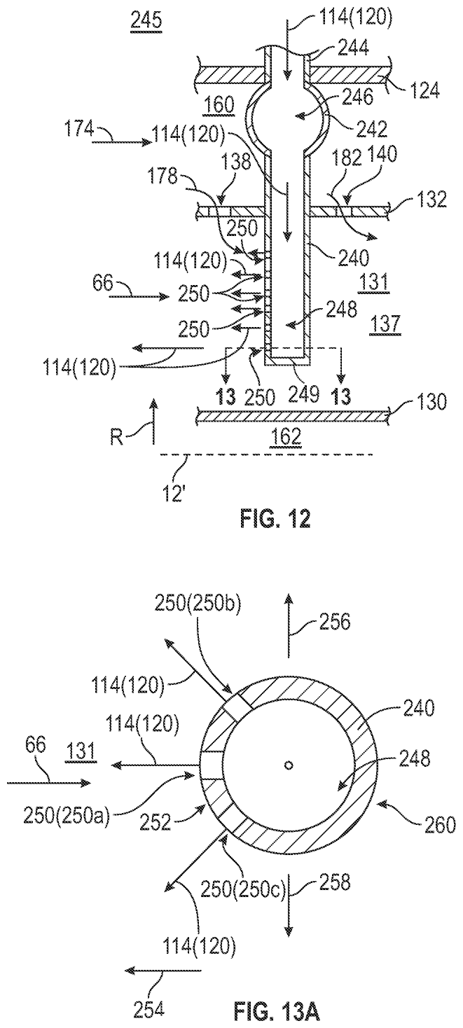

FIG. 11 is a partial cross-sectional side view of a combustor 26d, with another alternate arrangement of steam injection nozzles, according to an aspect of the present disclosure. As shown in FIG. 11, the combustor 26d includes a steam injection nozzle 240 that is connected to an outer steam manifold 242 that receives a flow of the steam 114 or the steam 120 via a steam supply line connector 244 that is connected to the steam supply line 98 or to the steam supply line 94. The steam injection nozzle 240 extends through the outer airflow passage 160, and through the outer liner 132 across the combustion chamber 131 so that an end of the steam injection nozzle 240 is adjacent to the inner liner 130.

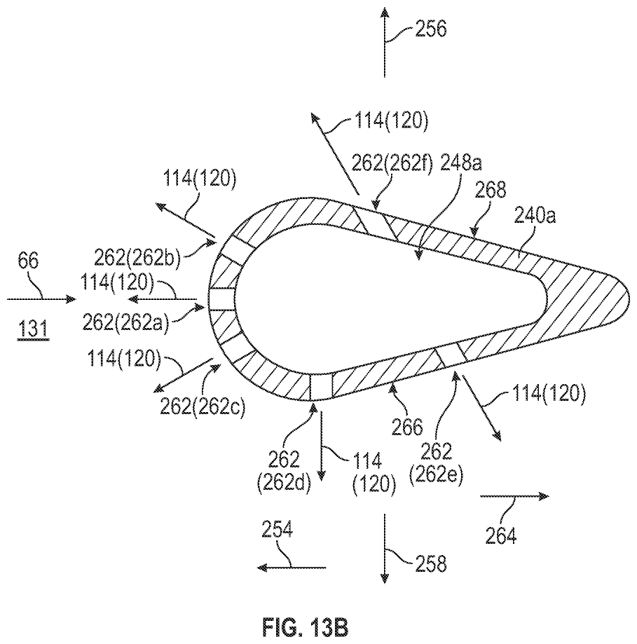

FIG. 12 is an enlarged, cross-sectional, detail view of the steam injection nozzle 240 of FIG. 11, taken at detail view 245, according to an aspect of the present disclosure. As shown in FIG. 12, the outer steam manifold 242 includes a steam passage 246 that receives the flow of the steam 114 or the steam 120 from the steam supply line connector 244. The steam injection nozzle 240 also includes a steam passage 248 that receives the flow of the steam 114 or the steam 120 from the steam passage 246 of the outer steam manifold 242. The steam injection nozzle 240 has a closed tip 249 and includes a plurality of steam injection ports 250 that provide a flow of the steam 114 or the steam 120 therethrough from the steam passage 248 into the combustion chamber 131. The steam injection ports 250 are shown as being arranged adjacent to one another so as to be dispersed radially (i.e., in the radial direction R) across the combustion chamber 131 between the outer liner 132 and the inner liner 130, thereby providing for a more even distribution of the steam 114 or the steam 120 in the radial direction R across the combustion chamber 131.

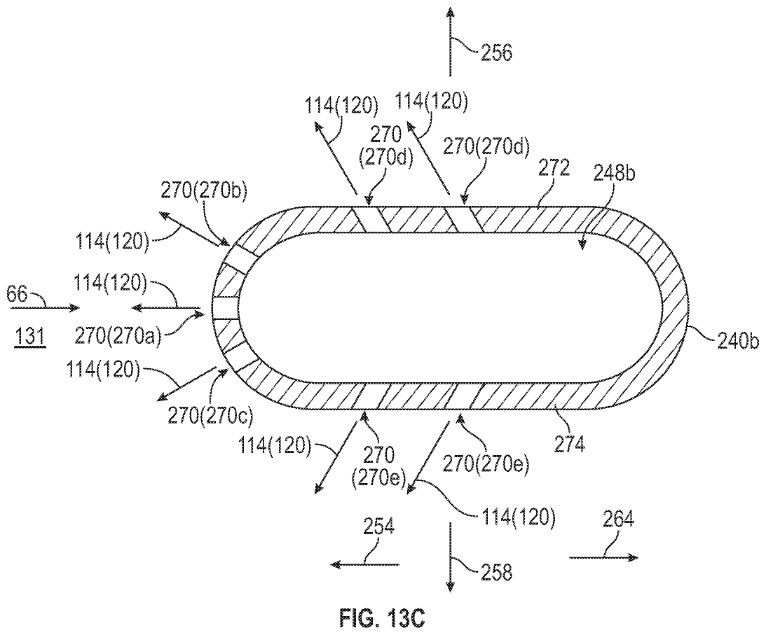

FIG. 13A is a partial cross-sectional view through the steam injection nozzle 240, taken at plane 13-13 of FIG. 12, according to an aspect of the present disclosure. As shown in FIG. 13A, the steam injection nozzle 240 may be a generally cylindrical cross section, similar to the outer steam injection nozzle 204 shown in FIG. 8. The steam injection ports 250 are shown to be arranged to inject the steam 114 or the steam 120 through an upstream side 252 of the steam injection nozzle 240. For example, a first steam injection port 250a is arranged to inject the steam 114 or the steam 120 in an upstream direction 254, which is generally opposite the axial flow direction of the combustion gases 66 within the combustion chamber 131. A second steam injection port 250b is arranged to inject the steam 114 or the steam 120 in the upstream direction 254 and in a first lateral direction 256, while a third steam injection port 250c is arranged to inject the steam 114 or the steam 120 in the upstream direction 254 and in a second lateral direction 258. While not shown in FIG. 13A, additional steam injection ports 250 may be included on a downstream side 260 of the steam injection nozzle 240. In addition, while the arrangement of the steam injection ports 250 is shown at the plane 13-13, a similar arrangement can be implemented at additional planes commensurate with each of the additional radially adjacent steam injection ports 250 shown in FIG. 12.

FIG. 13B depicts an alternate arrangement to the cross section of FIG. 13A, according to another aspect of the present disclosure. In the FIG. 13B aspect, an alternate steam injection nozzle 240a is shown to have a teardrop (or airfoil) shape. The alternate steam injection nozzle 240a includes a plurality of steam injection ports 262 that provide a flow of the steam 114 or the steam 120 therethrough from a steam passage 248a into the combustion chamber 131. The steam injection ports 262 may be arranged to provide the flow of the steam 114 or the steam 120 in varying directions. For example, the alternate steam injection nozzle 240a may include a first steam injection port 262a, a second steam injection port 262b, and a third steam injection port 262c that are each arranged similar to the first steam injection port 250a, the second steam injection port 250b, and the third steam injection port 250c of FIG. 13A. However, the alternate steam injection nozzle 240a may include additional steam injection ports 262, such as a fourth steam injection port 262d that is arranged to inject the steam 114 or the steam 120 in the second lateral direction 258. Further, one or more fifth steam injection ports 262e (one shown in FIG. 13B) may be arranged through a first sidewall 266 of the alternate steam injection nozzle 240a, and may be arranged to inject the steam 114 or the steam 120 in the second lateral direction 258 and in a downstream direction 264. Still further, one or more sixth steam injection ports 262f (one shown in FIG. 13A) may be arranged through a second sidewall 268 of the alternate steam injection nozzle 240a, and may be arranged to inject the steam 114 or the steam 120 in the first lateral direction 256 and in the upstream direction 254. Of course, the steam injection ports 262 could be arranged in any other manner instead, and the present disclosure is not limited to the arrangement shown in FIG. 13B.

FIG. 13C depicts still another alternate arrangement to the cross section shown in FIG. 13A, according to another aspect of the present disclosure. In the FIG. 13C aspect, an alternate steam injection nozzle 240b is shown to have an oval (or a racetrack) shape. The alternate steam injection nozzle 240b includes a plurality of steam injection ports 270 that provide a flow of the steam 114 or the steam 120 therethrough from a steam passage 248b into the combustion chamber 131. The steam injection ports 270 may be arranged to provide the flow of the steam 114 or the steam 120 in varying directions. For example, the alternate steam injection nozzle 240b may include a first steam injection port 270a, a second steam injection port 270b, and a third steam injection port 270c that are each arranged similar to the first steam injection port 250a, the second steam injection port 250b, and the third steam injection port 250c of FIG. 13A. However, the alternate steam injection nozzle 240b may include additional steam injection ports 270, such as one or more fourth steam injection ports 270d that are arranged through a first sidewall 272 to inject the steam 114 or the steam 120 in the upstream direction 254 and in the first lateral direction 256. Further, one or more fifth steam injection ports 270e may be arranged through a second sidewall 274 of the alternate steam injection nozzle 240b, and may be arranged to inject the steam 114 or the steam 120 in the upstream direction 254 and in the second lateral direction 258. Of course, the steam injection ports 270 could be arranged in any other manner instead, and the present disclosure is not limited to the arrangement shown in FIG. 13C.

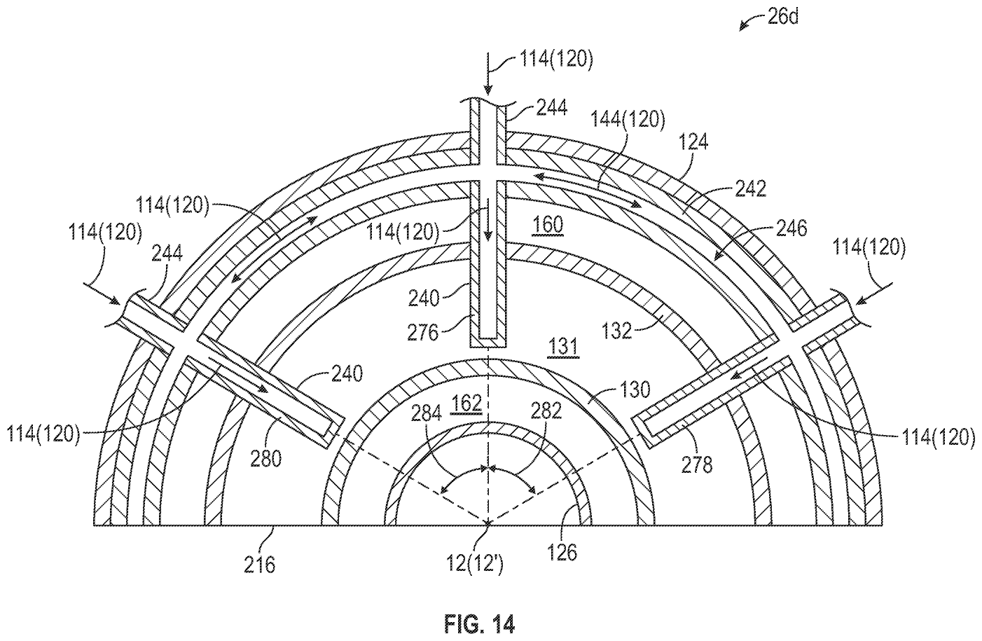

FIG. 14 is a partial cross-sectional view of the combustor 26d of FIG. 11, taken at plane 14-14 in FIG. 11, according to an aspect of the present disclosure. As with the FIG. 6 aspect and the FIG. 10 aspect, the partial cross section shown in FIG. 14 only depicts an upper half (i.e., above the horizontal reference plane 216) of the combustor 26d, and a lower half (below the horizontal reference plane 216) may be a mirror image of the upper portion. In FIG. 14, the combustor 26d is shown to include a plurality of the steam injection nozzles 240, including a first steam injection nozzle 276, a second steam injection nozzle 278, and a third steam injection nozzle 280. Each of the plurality of steam injection nozzles 240 is circumferentially spaced apart from each other. For example, the first steam injection nozzle 276 may be circumferentially spaced apart from the second steam injection nozzle 278 by a circumferential angle 282, which may be, for example, sixty degrees. The first steam injection nozzle 276 may also be circumferentially space apart from the third steam injection nozzle 280 by a circumferential angle 284, which may also be sixty degrees. In addition, in FIG. 14, the outer steam manifold 242 is shown to be an annular steam manifold (only the half above the horizontal reference plane 216 being shown in FIG. 14), and the steam passage 246 also extends annularly so that the steam 114 or the steam 120 flows annularly therewithin and can feed the steam 114 or the steam 120 to the plurality of steam injection nozzles 240. The combustor 26d may also include a plurality of the steam supply line connectors 244 that each may be connected to the steam supply line 98 or to the steam supply line 94. Therefore, with the arrangement of FIG. 14, the steam 114 or the steam 120 can be distributed circumferentially within the combustion chamber 131.

The foregoing arrangements provide for the injection of steam into the secondary combustion zone 137 of the combustion chamber 131, either by injecting the steam 114 or the steam 120 into the downstream portion 196 of the outer airflow passage 160 and into the downstream portion 198 of the inner airflow passage 162, or by injecting the steam 114 or the steam 120 directly into the combustion chamber 131. The steam 114 or the steam 120 injected into the outer airflow passage 160 can mix with the compressed air 174 in the downstream portion 196, and, then, the steam-air mixture 182′can flow through the secondary combustion zone liner openings 140 into the secondary combustion zone 137. Similarly, the steam 114 or the steam 120 injected into the inner airflow passage 162 can mix with the compressed air 176 in the downstream portion 198, and, then the steam-air mixture 188′ can flow through the secondary combustion zone liner openings 146 into the secondary combustion zone 137. In other embodiments, the steam 114 or the steam 120 is injected directly into the secondary combustion zone 137 of the combustor 26 so that the steam 114 or the steam 120 can mix directly with the combustion gases 66 in the secondary combustion zone 137, without injecting the steam 114 or the steam 120 into the primary combustion zone 133, thereby reducing the possibility of inducing a flameout condition within the primary combustion zone 133.

While the foregoing description relates generally to a gas turbine engine, the gas turbine engine may be implemented in various environments. For example, the engine may be implemented in an aircraft, but may also be implemented in non-aircraft applications, such as power generating stations, marine applications, or oil and gas production applications. Therefore, the present disclosure is not limited to use in aircraft.

Further aspects of the present disclosure are provided by the subject matter of the following clauses.

A gas turbine engine includes a steam generating system that generates steam, and a combustor comprising a combustor liner including an outer liner and an inner liner defining a combustion chamber therebetween, the combustion chamber having a primary combustion zone arranged at an upstream portion of the combustion chamber, and a secondary combustion zone arranged downstream of the primary combustion zone, at least one of the outer liner or the inner liner including a plurality of secondary combustion zone liner openings therethrough, an outer casing arranged outward of the outer liner, an outer airflow passage being defined between the outer casing and the outer liner, an inner casing arranged inward of the inner liner, an inner airflow passage being defined between the inner casing and the inner liner, and at least one steam injection nozzle extending through the outer casing or extending through the inner casing, and arranged, during operation of the gas turbine engine, to provide a flow of the steam generated by the steam generating system to the secondary combustion zone of the combustion chamber, without providing the steam to the primary combustion zone of the combustion chamber.

The gas turbine engine according to the preceding clause, wherein the at least one steam injection nozzle includes at least one of an outer steam injection nozzle arranged through the outer casing, or an inner steam injection nozzle arranged through the inner casing.

The gas turbine engine according to any preceding clause, wherein the inner steam injection nozzle further extends through the inner airflow passage and through the inner liner via one of the plurality of secondary combustion zone liner openings of the inner liner to provide the flow of the steam directly into the secondary combustion zone.

The gas turbine engine according to any preceding clause, wherein the plurality of secondary combustion zone liner openings of the inner liner includes a plurality of inner liner dilution openings arranged at an upstream end of the secondary combustion zone, and the one of the plurality of secondary combustion zone liner openings of the inner liner constitutes one of the plurality of inner liner dilution openings.

The gas turbine engine according to any preceding clause, wherein the outer steam injection nozzle is arranged to inject the steam into a downstream portion of the outer airflow passage, the steam flowing from the downstream portion of the outer airflow passage through the plurality of secondary combustion zone liner openings of the outer liner into the secondary combustion zone of the combustion chamber.

The gas turbine engine according to any preceding clause, wherein the outer casing includes an outer steam manifold and the outer steam injection nozzle is in fluid communication with the outer steam manifold.

The gas turbine engine according to any preceding clause, wherein an airflow within the outer airflow passage flows in a downstream direction, and the outer steam injection nozzle is arranged to direct the flow of the steam at least partially in an upstream direction.

The gas turbine engine according to any preceding clause, wherein the inner steam injection nozzle is arranged to inject the steam into a downstream portion of the inner airflow passage, the steam flowing from the downstream portion of the inner airflow passage through the plurality of secondary combustion zone liner openings of the inner liner into the secondary combustion zone of the combustion chamber.

The gas turbine engine according to any preceding clause, wherein the inner casing includes an inner steam manifold and the inner steam injection nozzle is in fluid communication with the inner steam manifold.

The gas turbine engine according to any preceding clause, wherein an airflow within the inner airflow passage flows in a downstream direction, and the inner steam injection nozzle is arranged to direct the flow of the steam at least partially in an upstream direction.

The gas turbine engine according to any preceding clause, wherein the outer steam injection nozzle further extends through the outer airflow passage and through the outer liner via one of the plurality of secondary combustion zone liner openings of the outer liner to provide the flow of steam directly into the secondary combustion zone.

The gas turbine engine according to any preceding clause, wherein the plurality of secondary combustion zone liner openings of the outer liner includes a plurality of outer liner dilution openings arranged at an upstream end of the secondary combustion zone, and the one of the plurality of secondary combustion zone liner openings of the outer liner constitutes one of the plurality of outer liner dilution openings.

The gas turbine engine according to any preceding clause, wherein the outer steam injection nozzle extends across the secondary combustion zone of the combustion chamber between the outer liner and the inner liner.

The gas turbine engine according to any preceding clause, wherein the outer steam injection nozzle includes a plurality of steam injection ports arranged to inject the steam in an upstream direction or in the upstream direction and in a lateral direction, with respect to an axial flow direction within the combustion chamber.

The gas turbine engine according to any preceding clause, wherein (a) the plurality of secondary combustion zone liner openings through the outer liner includes a plurality of outer liner dilution openings arranged through the outer liner at an upstream end of the secondary combustion zone and circumferentially spaced apart from one another about a combustor longitudinal centerline axis, (b) the outer casing includes an outer steam manifold that extends at least partially annularly about the combustor longitudinal centerline axis, and (c) the outer steam injection nozzle includes a plurality of outer steam injection nozzles in fluid communication with the outer steam manifold, respective ones of the plurality of outer steam injection nozzles extending through a respective one of the plurality of outer liner dilution openings.

The gas turbine engine according to any preceding clause, wherein, between a respective pair of the plurality of outer steam injection nozzles, at least one of the plurality of outer liner dilution openings is arranged without a steam injection nozzle therethrough so as to provide the flow of dilution air through the outer liner into the secondary combustion zone of the combustion chamber.

The gas turbine engine according to any preceding clause, wherein (d) the plurality of secondary combustion zone liner openings through the inner liner includes a plurality of inner liner dilution openings arranged through the inner liner at an upstream end of the secondary combustion zone and circumferentially spaced apart from one another about the combustor longitudinal centerline axis, (e) the inner casing includes an inner steam manifold that extends at least partially annularly about the combustor longitudinal centerline axis, and (f) the inner steam injection nozzle includes a plurality of inner steam injection nozzles in fluid communication with the inner steam manifold, respective ones of the plurality of inner steam injection nozzles extending through a respective one of the plurality of inner liner dilution openings.

The gas turbine engine according to any preceding clause, further comprising an outer steam supply line in fluid communication with the outer steam manifold, and an inner steam supply line in fluid communication with the inner steam manifold, the outer steam supply line and the inner steam supply line connected to a steam supply line connector that is in fluid communication with the steam generating system so as to provide the flow of the steam to the outer steam manifold and to the inner steam manifold.

The gas turbine engine according to any preceding clause, wherein the plurality of outer steam injection nozzles extend through the outer liner into the secondary combustion zone of the combustion chamber.

The gas turbine engine according to any preceding clause, wherein at least one of the plurality of outer steam injection nozzles includes a steam passage therewithin and a closed tip with a plurality of steam injection ports providing a flow of steam from the steam passage, respective ones of the plurality of steam injection ports being arranged to direct the flow of steam in any one of an upstream direction, a downstream direction, or a lateral direction, with respect to an axial flow direction within the combustion chamber.

The gas turbine engine according to any preceding clause, wherein the steam injection nozzle includes a steam passage therewithin.

The gas turbine engine according to any preceding clause, wherein the steam injection nozzle has a circular cross-sectional shape, and the steam passage has a circular cross-sectional shape.

The gas turbine engine according to any preceding clause, wherein the steam injection nozzle has a teardrop shape cross-sectional shape or an airfoil cross-sectional shape, and the steam passage has a teardrop cross-sectional shape or an airfoil cross-sectional shape.

The gas turbine engine according to any preceding clause, wherein the steam injection nozzle has a racetrack cross-sectional shape or an oval cross-sectional shape, and the steam passage has a racetrack cross-sectional shape or an oval cross-sectional shape.

A combustor for a gas turbine engine, the gas turbine engine including a steam generating system that generates steam to be provided to the combustor, the combustor including a combustor liner including an outer liner and an inner liner defining a combustion chamber therebetween, the combustion chamber having a primary combustion zone arranged at an upstream portion of the combustion chamber, and a secondary combustion zone arranged downstream of the primary combustion zone, at least one of the outer liner or the inner liner including a plurality of secondary combustion zone liner openings therethrough, an outer casing arranged outward of the outer liner, an outer airflow passage being defined between the outer casing and the outer liner, an inner casing arranged inward of the inner liner, an inner airflow passage being defined between the inner casing and the inner liner, and at least one steam injection nozzle extending through the outer casing or extending through the inner casing, and arranged, during operation of the gas turbine engine, to provide a flow of the steam generated by the steam generating system to the secondary combustion zone of the combustion chamber, without providing the steam to the primary combustion zone of the combustion chamber.

The combustor according to the preceding clause, wherein the at least one steam injection nozzle includes at least one of an outer steam injection nozzle arranged through the outer casing, or an inner steam injection nozzle arranged through the inner casing.

The combustor according to any preceding clause, wherein the inner steam injection nozzle further extends through the inner airflow passage and through the inner liner via one of the plurality of secondary combustion zone liner openings of the inner liner to provide the flow of the steam directly into the secondary combustion zone.

The combustor according to any preceding clause, wherein the plurality of secondary combustion zone liner openings of the inner liner includes a plurality of inner liner dilution openings arranged at an upstream end of the secondary combustion zone, and the one of the plurality of secondary combustion zone liner openings of the inner liner constitutes one of the plurality of inner liner dilution openings.

The combustor according to any preceding clause, wherein the outer steam injection nozzle is arranged to inject the steam into a downstream portion of the outer airflow passage, the steam flowing from the downstream portion of the outer airflow passage through the plurality of secondary combustion zone liner openings of the outer liner into the secondary combustion zone of the combustion chamber.

The combustor according to any preceding clause, wherein the outer casing includes an outer steam manifold and the outer steam injection nozzle is in fluid communication with the outer steam manifold.

The combustor according to any preceding clause, wherein an airflow within the outer airflow passage flows in a downstream direction, and the outer steam injection nozzle is arranged to direct the flow of the steam at least partially in an upstream direction.

The combustor according to any preceding clause, wherein the inner steam injection nozzle is arranged to inject the steam into a downstream portion of the inner airflow passage, the steam flowing from the downstream portion of the inner airflow passage through the plurality of secondary combustion zone liner openings of the inner liner into the secondary combustion zone of the combustion chamber.

The combustor according to any preceding clause, wherein the inner casing includes an inner steam manifold and the inner steam injection nozzle is in fluid communication with the inner steam manifold.

The combustor according to any preceding clause, wherein an airflow within the inner airflow passage flows in a downstream direction, and the inner steam injection nozzle is arranged to direct the flow of the steam at least partially in an upstream direction. The combustor according to any preceding clause, wherein the outer steam

injection nozzle further extends through the outer airflow passage and through the outer liner via one of the plurality of secondary combustion zone liner openings of the outer liner to provide the flow of steam directly into the secondary combustion zone.

The combustor according to any preceding clause, wherein the plurality of secondary combustion zone liner openings of the outer liner includes a plurality of outer liner dilution openings arranged at an upstream end of the secondary combustion zone, and the one of the plurality of secondary combustion zone liner openings of the outer liner constitutes one of the plurality of outer liner dilution openings.

The combustor according to any preceding clause, wherein the outer steam injection nozzle extends across the secondary combustion zone of the combustion chamber between the outer liner and the inner liner.

The combustor according to any preceding clause, wherein the outer steam injection nozzle includes a plurality of steam injection ports arranged to inject the steam in an upstream direction or in the upstream direction and in a lateral direction, with respect to an axial flow direction within the combustion chamber.

The combustor according to any preceding clause, wherein (a) the plurality of secondary combustion zone liner openings through the outer liner includes a plurality of outer liner dilution openings arranged through the outer liner at an upstream end of the secondary combustion zone and circumferentially spaced apart from one another about a combustor longitudinal centerline axis, (b) the outer casing includes an outer steam manifold that extends at least partially annularly about the combustor longitudinal centerline axis, and (c) the outer steam injection nozzle includes a plurality of outer steam injection nozzles in fluid communication with the outer steam manifold, respective ones of the plurality of outer steam injection nozzles extending through a respective one of the plurality of outer liner dilution openings.

The combustor according to any preceding clause, wherein, between a respective pair of the plurality of outer steam injection nozzles, at least one of the plurality of outer liner dilution openings is arranged without a steam injection nozzle therethrough so as to provide the flow of dilution air through the outer liner into the secondary combustion zone of the combustion chamber.

The combustor according to any preceding clause, wherein (d) the plurality of secondary combustion zone liner openings through the inner liner includes a plurality of inner liner dilution openings arranged through the inner liner at an upstream end of the secondary combustion zone and circumferentially spaced apart from one another about the combustor longitudinal centerline axis, (e) the inner casing includes an inner steam manifold that extends at least partially annularly about the combustor longitudinal centerline axis, and (f) the inner steam injection nozzle includes a plurality of inner steam injection nozzles in fluid communication with the inner steam manifold, respective ones of the plurality of inner steam injection nozzles extending through a respective one of the plurality of inner liner dilution openings.

The combustor according to any preceding clause, further comprising an outer steam supply line in fluid communication with the outer steam manifold, and an inner steam supply line in fluid communication with the inner steam manifold, the outer steam supply line and the inner steam supply line connected to a steam supply line connector that is in fluid communication with the steam generating system so as to provide the flow of the steam to the outer steam manifold and to the inner steam manifold.

The combustor according to any preceding clause, wherein the plurality of outer steam injection nozzles extend through the outer liner into the secondary combustion zone of the combustion chamber.

The combustor according to any preceding clause, wherein at least one of the plurality of outer steam injection nozzles includes a steam passage therewithin and a closed tip with a plurality of steam injection ports providing a flow of steam from the steam passage, respective ones of the plurality of steam injection ports being arranged to direct the flow of steam in any one of an upstream direction, a downstream direction, or a lateral direction, with respect to an axial flow direction within the combustion chamber.

The combustor according to any preceding clause, wherein the steam injection nozzle includes a steam passage therewithin.

The combustor according to any preceding clause, wherein the steam injection nozzle has a circular cross-sectional shape, and the steam passage has a circular cross-sectional shape.

The combustor according to any preceding clause, wherein the steam injection nozzle has a teardrop shape cross-sectional shape or an airfoil cross-sectional shape, and the steam passage has a teardrop cross-sectional shape or an airfoil cross-sectional shape.

The combustor according to any preceding clause, wherein the steam injection nozzle has a racetrack cross-sectional shape or an oval cross-sectional shape, and the steam passage has a racetrack cross-sectional shape or an oval cross-sectional shape.

Although the foregoing description is directed to some exemplary embodiments of the present disclosure, other variations and modifications will be apparent to those skilled in the art, and may be made without departing from the disclosure. Moreover, features described in connection with one embodiment of the present disclosure may be used in conjunction with other embodiments, even if not explicitly stated above.

1. A gas turbine engine comprising:
a steam generating system that generates steam; and
a combustor comprising:
a combustor liner including an outer liner and an inner liner defining a combustion chamber therebetween, the combustion chamber having a primary combustion zone arranged at an upstream portion of the combustion chamber, a secondary combustion zone arranged downstream of the primary combustion zone, and a dilution zone arranged between the primary combustion zone and the secondary combustion zone, at least one of the outer liner or the inner liner including a plurality of dilution openings arranged to provide a flow of dilution air therethrough to the dilution zone, and a plurality of secondary combustion zone liner openings extending therethrough and arranged to provide a steam-air mixture therethrough into the secondary combustion zone;
an outer casing arranged outward of the outer liner, an outer airflow passage being defined between the outer casing and the outer liner;
an inner casing arranged inward of the inner liner, an inner airflow passage being defined between the inner casing and the inner liner; and
at least one steam injection nozzle extending through the outer casing or extending through the inner casing, and arranged, during operation of the gas turbine engine, to provide a flow of the steam generated by the steam generating system into the outer airflow passage or into the inner airflow passage to mix with an airflow within the outer airflow passage or to mix with an airflow within the inner airflow passage to generate the steam-air mixture within a downstream end of the outer airflow passage or within a downstream end of the inner airflow passage, and the steam-air mixture flowing through the plurality of secondary combustion zone liner openings into the secondary combustion zone of the combustion chamber, without providing the steam to the primary combustion zone or to the dilution zone of the combustion chamber.

2. The gas turbine engine according to claim 1, wherein the at least one steam injection nozzle includes at least one of an outer steam injection nozzle arranged through the outer casing, or an inner steam injection nozzle arranged through the inner casing.

3. The gas turbine engine according to claim 2, wherein the inner steam injection nozzle further extends through the inner airflow passage and through the inner liner via one of the plurality of secondary combustion zone liner openings of the inner liner to provide the flow of the steam directly into the secondary combustion zone.

4. The gas turbine engine according to claim 3, wherein the plurality of secondary combustion zone liner openings of the inner liner includes a plurality of inner liner dilution openings arranged at an upstream end of the secondary combustion zone, and the one of the plurality of secondary combustion zone liner openings of the inner liner constitutes one of the plurality of inner liner dilution openings.

5. (canceled)

6. The gas turbine engine according to claim 2, wherein the outer casing includes an outer steam manifold and the outer steam injection nozzle is in fluid communication with the outer steam manifold.

7. The gas turbine engine according to claim 2, wherein the airflow within the outer airflow passage flows in a downstream direction, and the outer steam injection nozzle is arranged to direct the flow of the steam at least partially in an upstream direction.

8. (canceled)

9. The gas turbine engine according to claim 2, wherein the inner casing includes an inner steam manifold and the inner steam injection nozzle is in fluid communication with the inner steam manifold.

10. The gas turbine engine according to claim 9, wherein the airflow within the inner airflow passage flows in a downstream direction, and the inner steam injection nozzle is arranged to direct the flow of the steam at least partially in an upstream direction.

11. The gas turbine engine according to claim 2, wherein the outer steam injection nozzle further extends through the outer airflow passage and through the outer liner via one of the plurality of secondary combustion zone liner openings of the outer liner to provide the flow of steam directly into the secondary combustion zone.

12. The gas turbine engine according to claim 11, wherein the plurality of secondary combustion zone liner openings of the outer liner includes a plurality of outer liner dilution openings arranged at an upstream end of the secondary combustion zone, and the one of the plurality of secondary combustion zone liner openings of the outer liner constitutes one of the plurality of outer liner dilution openings.

13. The gas turbine engine according to claim 11, wherein the outer steam injection nozzle extends across the secondary combustion zone of the combustion chamber between the outer liner and the inner liner.

14. The gas turbine engine according to claim 2, wherein the outer steam injection nozzle includes a plurality of steam injection ports arranged to inject the steam in an upstream direction or in the upstream direction and in a lateral direction, with respect to an axial flow direction within the combustion chamber.

15. The gas turbine engine according to claim 2, wherein (a) the plurality of secondary combustion zone liner openings through the outer liner includes a plurality of outer liner dilution openings arranged through the outer liner at an upstream end of the secondary combustion zone and circumferentially spaced apart from one another about a combustor longitudinal centerline axis, (b) the outer casing includes an outer steam manifold that extends at least partially annularly about the combustor longitudinal centerline axis, and (c) the outer steam injection nozzle includes a plurality of outer steam injection nozzles in fluid communication with the outer steam manifold, respective ones of the plurality of outer steam injection nozzles extending through a respective one of the plurality of outer liner dilution openings.

16. The gas turbine engine according to claim 15, wherein, between a respective pair of the plurality of outer steam injection nozzles, at least one of the plurality of outer liner dilution openings is arranged without a steam injection nozzle therethrough so as to provide the flow of dilution air through the outer liner into the secondary combustion zone of the combustion chamber.

17. The gas turbine engine according to claim 15, wherein (d) the plurality of secondary combustion zone liner openings through the inner liner includes a plurality of inner liner dilution openings arranged through the inner liner at an upstream end of the secondary combustion zone and circumferentially spaced apart from one another about the combustor longitudinal centerline axis, (e) the inner casing includes an inner steam manifold that extends at least partially annularly about the combustor longitudinal centerline axis, and (f) the inner steam injection nozzle includes a plurality of inner steam injection nozzles in fluid communication with the inner steam manifold, respective ones of the plurality of inner steam injection nozzles extending through a respective one of the plurality of inner liner dilution openings.

18. The gas turbine engine according to claim 17, further comprising an outer steam supply line in fluid communication with the outer steam manifold, and an inner steam supply line in fluid communication with the inner steam manifold, the outer steam supply line and the inner steam supply line connected to a steam supply line connector that is in fluid communication with the steam generating system so as to provide the flow of the steam to the outer steam manifold and to the inner steam manifold.

19. The gas turbine engine according to claim 2, wherein the plurality of outer steam injection nozzles extend through the outer liner into the secondary combustion zone of the combustion chamber.

20. The gas turbine engine according to claim 19, wherein at least one of the plurality of outer steam injection nozzles includes a steam passage therewithin and a closed tip with a plurality of steam injection ports providing a flow of steam from the steam passage, respective ones of the plurality of steam injection ports being arranged to direct the flow of steam in any of an upstream direction, a downstream direction, a lateral direction, an upstream-lateral direction, or a downstream-lateral direction, with respect to an axial flow direction within the combustion chamber.
